(19) United States
(12) Patent Application Publication
(10) Pub. No.: US 2007/0014909 A1
(43) Pub. Date: Jan. 18, 2007

(54) Acidic, protein-containing drinks with improved sensory and functional characteristics

(76) Inventors: Jimbin Mai, St. Louis, MO (US); Stephanie C. Carpenter, Olivette, MO (US); Derek Bader, Imperial, MO (US); Paul V. Paulsen, Kirkwood, MO (US); Theodore M. Wong, Ballwin, MO (US); Cheng Shen, Kirkwood, MO (US); Yadilka Maldanado, O'Fallon, MO (US); Andreas G. Altemueller, Webster Groves, MO (US); Daniel W. Brown, St. Louis, MO (US)

Correspondence Address: SOLAE, LLC, PO BOX 88940, ST. LOUIS, MO, 63188, US

(21) Appl. No.: 11/183,344

(22) Filed: Jul. 18, 2005

(51) Int. Cl. A23L 2/00

(52) U.S. Cl. 426/590

(57) ABSTRACT

Processes for producing acidic, protein-containing drinks are disclosed. Specifically, the processes comprise producing acidic, protein-containing drinks comprising plant protein material. The acidic, protein-containing drinks have improved sensory and functional characteristics such as reduced viscosity, improved sedimentation rate, and improved mouthfeel.

### BACKGROUND OF THE INVENTION

The present invention generally relates to acidic, protein-containing drinks and processes for producing the same. More particularly, the present invention relates to acidic, protein-containing drinks comprising plant protein material, such as soy protein concentrates and isolates having a low concentration of phytic acid, and exhibiting excellent sensory and functional characteristics, such as viscosity, sedimentation rate, overall liking, flavor, and mouthfeel.

Proteins derived from plant material have been utilized as an edible source of proteins for some time, and are commonly included in a number of consumer food items, including meat products, fishery paste products, side dishes, bread, confectionery products and acidic beverages, such as soft drinks, sport drinks, and juices. The added protein provides an additional source of nutrition in the food or beverage products. Recently, it has been discovered that plant proteins, and specifically soy proteins, provide additional health benefits, such as reducing blood cholesterol levels, as well as providing excellent nutritional benefits. As a result, there has been growing consumer demand for food items and acidic drinks containing these proteins.

One problem with adding soy protein to acidic beverages, however, is the relative insolubility of the soy proteins in an aqueous acidic environment. Most commonly used proteins, such as soy proteins, have an isoelectric point at an acidic pH. Thus, the proteins are least soluble in an aqueous liquid at or near the pH of acidic beverages. As a result, added soy protein tends to settle out of protein-containing acidic drinks. In addition, many acidic drinks to which soy proteins are added have an undesirable aftertaste and/or poor mouthfeel due to the addition of the soy proteins.

Previous attempts have been made to improve the solubility of plant proteins in acidic drinks. These attempts have been mainly directed toward preventing the aggregation and/or precipitation of the proteins at a low pH. For example, some processes have added a stabilizer such as pectin, or an emulsifier to plant protein containing acidic drinks to improve the solubility of the plant proteins. However, adding conventional stabilizers to plant protein containing acidic drinks may give the drinks a higher viscosity and an undesirable, thicker mouthfeel. Additionally, attempts have been made to increase the solubility of plant proteins in acidic drinks by subjecting the plant proteins to enzymatic hydrolysis to cleave the proteins into smaller peptides that have improved solubility, or by chemically modifying the plant proteins through succinylation to improve their solubility in the pH range of about 3 to 5. However, the presence of short chain peptides resulting from hydrolysis of plant proteins often results in a plant protein product with a bitter, undesirable flavor.

Recently, attempts have been made to improve the solubility of plant proteins in acidic drinks by reducing the amount of phytic acid (or phytate) present in plant proteins. For example, European Patent Application No. 0 380 343 discloses methods of reducing or eliminating phytate in soy protein compositions by treating the soy protein with a phytate degrading enzyme under certain pH and temperature conditions at various points during the preparation of soy protein isolates and concentrates. WO 02/067690 also discloses methods of improving the solubility of soy proteins in an acidic environment by treating the soy proteins with a phytate degrading enzyme (e.g., phytase). Although the soy protein products produced by these processes have somewhat improved solubility in acidic compositions, flavor issues, such as an increased astringent taste and viscosity, remain problematic.

Thus, although some conventional approaches have generally increased solubility or stability of plant proteins in acidic, protein-containing drinks, acidic, protein-containing drinks containing plant proteins produced by these approaches still may have an undesirable astringent aftertaste or a thicker, unpleasant mouthfeel. As such, a need exists in the industry for acidic, protein-containing drinks (and processes for producing acidic, protein-containing drinks) that exhibit good viscosity, reduced sedimentation rate, good overall liking, flavor, and mouthfeel.

### SUMMARY OF THE INVENTION

Generally, the present invention provides for acidic, protein-containing drinks comprising plant protein material and methods for producing the same. In one embodiment, the plant protein material for use in the acidic, protein-containing drink is a soy protein material, such as a soy protein isolate. These acidic, protein-containing drinks provide for improved sensory and functional characteristics. Specifically, the acidic, protein-containing drinks provide for an improved viscosity, sedimentation rate, good overall liking, flavor, and mouthfeel, and have significantly reduced shake back times as compared to acid protein-containing drinks prepared by conventional processes.

Additionally, the present invention provides for soy protein products such as soy protein isolates and soy protein concentrates that comprise a reduced amount of phytic acid, and methods of producing the same. The soy protein products have improved suspendability in acidic environments and may have better flavor as compared to previously available soy protein products. The soy protein products can be produced by treating a soy protein material with a phytic acid degrading enzyme during processing. The resulting soy protein products have a phytic acid content of from about 0.1% to about 1.3% (by weight total solids). By reducing the amount of phytic acid in the soy protein products, the suspendability of the soy protein products in acidic drinks is improved. In addition, it has been discovered that the astringent taste that may be associated with soy protein products that have been treated with a phytic acid degrading enzyme, such as phytase, may be reduced when phytic acid degrading enzyme treated soy protein products are dried at a neutral pH.

As such, the present invention is directed to a process for producing an acidic, protein-containing drink. The process comprises adjusting the pH of an acidic beverage to a pH of from about 1.0 to about 4.4, hydrating a plant protein material in the acidic beverage to form an acidic, protein-containing solution, introducing an enzyme into the acidic, protein-containing solution, heating the enzyme treated acidic, protein-containing solution to a temperature of from about 85° C. to about 95° C. and holding the enzyme treated acidic, protein-containing solution at that temperature for a period of from about 30 seconds to about 50 minutes to form the acidic, protein-containing drink.

The present invention is further directed to an acidic, protein-containing drink comprising from about 0.5% (by weight) to about 10% (by weight) plant protein material. The acidic, protein-containing drink has a pH of from about 3.5 to about 5.0, a viscosity (at 10% solids basis) at a temperature of about 25° C. of from about 1.0 centipoise to about 10 centipoise, and less than about 3% sedimentation at day 30.

The present invention is further directed to an acidic, protein-containing drink comprising from about 0.5% (by weight) to about 10% (by weight) plant protein material. The acidic, protein-containing drink has a pH of from about 3.5 to about 5.0, a viscosity (at 10% solids basis) at a temperature of about 25° C. of from about 1.0 centipoise to about 10 centipoise, and less than about 3% sedimentation at day 30. The acidic, protein-containing drink is prepared from a process comprising adjusting the pH of an acidic beverage to a pH of from about 1.0 to about 4.4, hydrating a plant protein material in the acidic beverage to form an acidic, protein-containing solution, introducing an enzyme into the acidic, protein-containing solution, heating the enzyme treated acidic, protein-containing solution to a temperature of from about 85° C. to about 95° C. and holding the enzyme treated acidic, protein-containing solution at that temperature for a period of from about 30 seconds to about 50 minutes.

The present invention is further directed to a process for producing an acidic, protein-containing drink. The process comprises adjusting the pH of an acidic beverage to a pH of from about 1.0 to about 3.8, hydrating a plant protein material in the acidic beverage to form an acidic, protein-containing solution, heating the acidic, protein-containing solution to a temperature of from about 85° C. to about 95° C. and holding the acidic, protein-containing solution at that temperature for a period of from about 30 seconds to about 50 minutes to form the acidic, protein-containing drink.

The present invention is further directed to an acidic, protein-containing drink comprising from about 0.5% (by weight) to about 10% (by weight) plant protein material. The acidic, protein-containing drink has a pH of from about 3.5 to about 5.0, a viscosity (at 10% solids basis) at a temperature of about 25° C. of from about 1.0 centipoise to about 10 centipoise, and less than about 3% sedimentation at day 30. The acidic, protein-containing drink is substantially free of a mouthfeel modifying agent.

The present invention is further directed to an acidic, protein-containing drink comprising from about 0.5% (by weight) to about 10% (by weight) plant protein material. The acidic, protein-containing drink has a pH of from about 3.5 to about 5.0, a viscosity (at 10% solids basis) at a temperature of about 25° C. of from about 1.0 centipoise to about 10 centipoise, and less than about 3% sedimentation at day 30. The acidic, protein-containing drink is substantially free of a mouthfeel modifying agent. The acidic, protein-containing drink is prepared by a process comprising adjusting the pH of an acidic beverage to a pH of from about 1.0 to about 3.8, hydrating a plant protein material in the acidic beverage to form an acidic, protein-containing solution, heating the acidic, protein-containing solution to a temperature of from about 85° C. to about 95° C. and holding the acidic, protein-containing solution at that temperature for a period of from about 30 seconds to about 50 minutes.

The present invention is further directed to a process for producing a soy protein product. The process comprises: preparing a soy protein extract from a soy protein-containing plant material; contacting the soy protein extract with an acid to form a soy protein precipitate; contacting the soy protein precipitate with a hydrating solution to form a soy protein suspension; introducing a phytic acid degrading enzyme into the soy protein suspension and reacting the soy protein suspension with the phytic acid degrading enzyme for from about 30 seconds to about 50 minutes to form a modified soy protein material; adjusting the pH of the modified soy protein material to a pH of from about 6.5 to about 8.0 to form a neutralized soy protein material; heating the neutralized soy protein material to a temperature of from about 132° C. to about 160° C. for from about 1 second to about 30 seconds to form a heat treated soy protein material; and drying the heat treated soy protein material to form the soy protein product; wherein the soy protein product comprises from about 0.1% to about 1.3% (by weight total solids) phytic acid.

In another embodiment, the present invention provides a process for producing a soy protein product. The process comprises: preparing a soy protein extract from a soy protein-containing plant material; introducing a phytic acid degrading enzyme into the soy protein extract and reacting the soy protein extract with the phytic acid degrading enzyme for from about 30 seconds to about 50 minutes to form a modified soy protein extract; contacting the modified soy protein extract with an acid to form a modified soy protein precipitate; contacting the modified soy protein precipitate with a hydrating solution to form a modified soy protein suspension; adjusting the pH of the modified soy protein suspension to a pH of from about 6.5 to about 8.0 to form a neutralized soy protein material; heating the neutralized soy protein material to a temperature of from about 132° C. to about 160° C. for from about 1 second to about 30 seconds to form a heat treated soy protein material; and drying the heat treated soy protein material to form the soy protein product; wherein the soy protein product comprises from about 0.1% to about 1.3% (by weight total solids) phytic acid.

In still another embodiment, the present invention provides a process for producing a soy protein product. The process comprises: preparing a soy protein extract from a soy protein-containing plant material; contacting the soy protein extract with an acid to form a soy protein precipitate; contacting the soy protein precipitate with a hydrating solution to form a soy protein suspension; adjusting the pH of the soy protein suspension to a pH of from about 6.5 to about 8.0 to form a neutralized soy protein material; introducing a phytic acid degrading enzyme into the neutralized soy protein material and reacting the neutralized soy protein material with the phytic acid degrading enzyme for from about 30 seconds to about 50 minutes to form a modified soy protein material, wherein the pH of the modified soy protein material is from about 6.5 to about 8.0; heating the modified soy protein material to a temperature of from about 132° C. to about 160° C. for from about 1 second to about 30 seconds to form a heat treated soy protein material; and drying the heat treated soy protein material to form the soy protein product; wherein the soy protein product comprises from about 0.1% to about 1.3% (by weight total solids) phytic acid.

Also provided are soy protein products produced by these processes, and acidic, protein-containing drinks comprising the soy protein products of the present invention.

The present invention also provides soy protein isolates and concentrates comprising from about 0.1% to about 1.3% (by weight total solids) phytic acid, wherein the soy protein isolate or concentrate has been dried at a pH of from about 6.5 to about 8.0 during processing, and acidic, protein-containing drinks comprising these isolates or concentrates.

Other features and advantages of this invention will be in part apparent and in part pointed out hereinafter.

### DETAILED DESCRIPTION OF THE PREFERRED EMBODIMENTS

The present invention is generally directed to acidic, protein-containing drinks comprising plant protein material and processes for producing the same. The process utilized to produce the acidic, protein-containing drink may include an enzyme treatment step. In one embodiment, the acidic, protein-containing drinks comprise soy protein material as the plant protein material. Surprisingly, it has been discovered that by hydrating the plant protein material in an acidic beverage at a pH below the isoelectric point of the plant protein material, the solubility of the plant protein material in the acidic beverage is dramatically increased. The present invention is also generally directed to processes for producing soy protein products, such as soy protein isolates and concentrates, with a reduced amount of phytic acid, and the use of these soy protein products in acidic, protein-containing drinks. The soy protein products produced by the novel process described herein have excellent solubility, suspension stability, and flavor in acidic drinks.

Processes For Producing Acidic, Protein-Containing Drinks

Generally, the processes of the present invention for producing the acidic, protein-containing drinks include the steps of: (1) adjusting the pH of an acidic beverage; (2) hydrating a plant protein material in the acidic beverage to form an acidic, protein-containing solution; and (3) heating the acidic, protein-containing solution to a temperature of from about 85° C. to about 95° C. and holding the acidic, protein-containing solution at that temperature for a period of about 30 seconds to about 50 minutes to form the acidic, protein-containing drink. In one embodiment, the process further comprises introducing an enzyme, such as a phytic acid degrading enzyme, into the acidic, protein-containing solution prior to heating the acidic, protein-containing solution and allowing the enzymes to react with the plant protein material for a time period prior to heating.

As noted above, the processes of the present invention include first adjusting the pH of an acidic beverage. As used herein, the term “acidic beverage” refers to a beverage having a pH, prior to any pH adjustment, of from about 2.0 to about 5.5. Suitable acidic beverages for use in the processes of the present invention can include, for example, sports drinks such as Gatorade® or Powerade®, soft drinks such as Coke®, Pepsi®, etc., alcohol-containing drinks such as wine coolers, wine spritzers, and fruit or vegetable juices or juice concentrates such as V8® juice, orange juice, grape juice, apple juice, cranberry juice, and the like. The acidic beverages can be carbonated or non-carbonated. Preferred acidic beverages for use in the processes of the present invention include fruit or vegetable juices or juice concentrates. Preferred fruit and vegetable juices and juice concentrates include apple juice, grape juice, orange juice, carrot juice, cherry juice, tomato juice, passionfruit juice, mango juice, grape juice, apple juice, cranberry juice, blends thereof, and their concentrates.

The pH of the acidic beverage can be adjusted using any organic or inorganic acid or base suitable for consumption. Suitably, when the pH of the acidic beverage is adjusted using acids, acids such as citric acid, phosphoric acid, hydrochloric acid, malic acid, sodium acid sulfate, and combinations thereof can be used. When the pH of the acidic beverage is adjusted using bases, bases such as 45% potassium hydroxide can be used. When the process for producing the acidic, protein-containing drink does not include an enzyme treatment as described below, the pH of the acidic beverage is suitably adjusted to a pH of from about 1.0 to about 3.8, more suitably, to a pH of from about 1.0 to about 3.5, and even more suitably, to a pH of from about 1.0 to about 3.0. When the process for producing the acidic, protein-containing drink includes an enzyme treatment, the pH of the acidic beverage is suitably adjusted to a pH of from about 1.0 to about 4.4, more suitably, to a pH of from about 1.0 to about 4.0, and even more suitably, to a pH of from about 1.0 to about 3.5. By adjusting the pH of the acidic beverage to these levels, the solubility of the plant protein material in the acid beverage is significantly increased.

Once the pH of the acidic beverage has been adjusted, a plant protein material is hydrated in the acidic beverage to form an acidic, protein-containing solution. In one embodiment, water can be added to the acidic beverage prior to hydrating a plant protein material with the acidic beverage to improve hydration. As used herein, the term “hydrating” refers to a static or dynamic soaking of the plant protein material to introduce the acidic beverage therein. Typically, the plant protein material is contacted with the acidic beverage for about 5 minutes to form the acidic, protein-containing solution.

Suitably, from about 0.5% (by weight acidic beverage) to about 10% (by weight acidic beverage) plant protein material is hydrated in the acidic beverage to form an acidic, protein-containing solution. More suitably, from about 1.2% (by weight acidic beverage) to about 5.0% (by weight acidic beverage) plant protein material is hydrated in the acidic beverage to form an acidic, protein-containing solution. As no significant amount of plant protein material is lost during hydration or further processing, the acidic, protein-containing solution will comprise from about 0.5% (by weight) to about 10% (by weight) plant protein material, more suitably from about 1.2% (by weight) to about 5.0% (by weight) plant protein material.

Suitably, the plant protein material for use in the processes of the present invention is an intact plant protein material. As used herein, “intact” plant protein materials refer to plant protein materials that have not been hydrolyzed by an enzyme treatment, heat treatment, or acid/alkali treatment prior to use. As such, suitable plant protein material for use in the processes of the present invention can include materials such as soy protein material, rapeseed protein material, wheat gluten material, pea protein material, lupin protein material, rice material and legume protein material. Particularly preferred plant protein material is intact soy protein material. Suitably, when the plant protein material is a soy protein material, the soy protein material is selected from the group consisting of soymilk or soymilk concentrates, soy flakes, soy flour, soy grits, soy meal, soy protein concentrates, soy protein isolates, and mixtures thereof. The primary difference between these soy protein materials is the degree of refinement relative to whole soybeans.

Soymilk and soymilk concentrates have been prepared for hundreds of years in the Orient by traditional water-extraction methods. One suitable water-extraction method still used today generally includes soaking soybeans in water for several hours to produce swollen soybeans. The swollen soybeans are then drained and ground with additional water, preferably with softened water or more preferably with distilled water, and then digested at a temperature of about 70° C. to about 90° C. so that a soybean slurry is obtained. The soybean slurry is then filtered through a filter cloth to separate the soy pulp and the soymilk. Once separated, the soymilk can be used without further processing as the soy protein material. Alternatively, a soymilk concentrate can be produced from the soymilk by any conventional manner known in the art. For example, a soymilk concentrate can be produced by the methods of evaporation, skimming off fat, or centrifugation.

Soy flakes are generally produced by dehulling, defatting, and grinding the soybean and typically contain less than about 60% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than about 150 μm. Soy grits generally have a particle size of about 150 to about 1000 μm. Soy meal generally has a particle size of greater than about 1000 μm.

Soy protein concentrates typically contain about 60% (by weight) to less than 90% (by weight) soy protein on a moisture free basis, with the major non-protein component being fiber. Soy protein concentrates are typically formed from defatted soy flakes by washing the flakes with either an aqueous alcohol solution or an acidic aqueous solution to remove the soluble carbohydrates from the protein and fiber.

Soy protein isolates, which are more highly refined soy protein materials, are processed to contain at least 90% (by weight) soy protein on a moisture free basis and little or no soluble carbohydrates or fiber. Soy protein isolates are typically formed by extracting soy protein and water soluble carbohydrates from defatted soy flakes or soy flour with an aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein to precipitate the protein from the extract. The precipitated protein is separated from the extract, which retains the soluble carbohydrates, and is dried after an optional pH adjustment step.

Particularly preferred soy protein materials for use as the plant protein material described herein include soy protein isolates and soy protein concentrates. In general, methods for producing soy protein isolates and soy protein concentrates comprise: (1) preparing a soy protein extract from a soy protein-containing plant material, such as soy flakes or soy flour; (2) contacting the soy protein extract with an acid to form a precipitated soy protein curd; (3) optionally contacting the precipitated soy protein curd with a hydrating solution comprising water, for example, to form a precipitated soy protein curd suspension; and (4) drying the precipitated soy protein curd or the precipitated soy protein curd suspension to form the soy protein isolate or soy protein concentrate.

Extraction processes and processes for forming soy protein curds are well known in the art, and any such process may be used herein to produce a precipitated soy protein curd. One example of a suitable process for preparing soy protein curds includes cracking soybeans to remove the hull, rolling them into flakes with flaking machines, defatting the flakes with hexane or heptane, subjecting the flakes to an extraction process, suspending the extracted soy protein in a wash solution, and precipitating a soy protein curd therefrom. Suitable flaking machines may consist of a pair of horizontal counter-rotating smooth steel rolls. The rolls are pressed one against the other by means of heavy springs or by controlled hydraulic systems. The soybeans are fed between the rolls and are flattened as the rolls rotate one against the other. The roll-to-roll pressure can be regulated to determine the average thickness of the flakes. The rolling process disrupts the oil cell, facilitating solvent extraction of the oil. Specifically, flaking increases the contact surface between the oilseed tissues and the extractant, and reduces the distance that the extractant and the extract will have to travel in the extraction process as described herein below. Typical values for flake thickness are in the range of 0.2 to 0.35 millimeters. The defatted soy flake material may then be used to produce a soy protein isolate or a soy protein concentrate.

When a soy protein concentrate is being produced, the defatted soy flake material may then be put through a solvent extraction process. Typically, the solvent for the extraction process is an aqueous acid or alcohol wash. The aqueous acid or alcohol wash removes materials soluble therein, including a substantial portion of the carbohydrates. This produces a protein concentrate material that contains from about 60% to less than 90% protein by weight on a dry basis.

Alcohol extraction to remove alcohol soluble components from the protein is particularly preferred in the solvent extraction process since alcohol extraction generally produces a better tasting soy protein material compared to aqueous acid extraction. This type of extraction is based on the ability of the wash solvent solutions to extract the soluble sugar/carbohydrate fraction of the defatted soy flake without solubilizing its proteins. A suitable alcohol solvent is an aqueous solution of lower aliphatic alcohols, such as, methanol, ethanol, and isopropyl alcohol. Typically, the alcohol wash should be a food grade reagent, and preferably is an aqueous ethanol solution. An aqueous ethanol solution may contain from about 55% to about 90% ethanol by volume. The soy flake material should be contacted with sufficient wash solution to form a soy protein concentrate containing between about 60% to less than 90% protein, by dry weight.

When a soy protein isolate is being produced, the defatted soy flake material may then be put through an aqueous extraction process. Typically, the aqueous extraction process is an aqueous alkaline wash. The aqueous alkaline wash removes materials soluble therein, including a substantial portion of the carbohydrates. This produces a protein material that contains at least about 90% protein by weight on a dry basis.

Typically, the alkaline wash has a pH of from 8.5 to about 10. The extraction is generally conducted by contacting the defatted soy flakes with an aqueous solution containing a set amount of base, such as sodium hydroxide, potassium hydroxide, ammonium hydroxide and/or calcium hydroxide, and allowing the pH to slowly decrease as the base is neutralized by substances extracted out of the solid soy flakes. The initial amount of base is typically chosen so that at the end of the extraction operation the extract has a desired pH value, e.g., a pH within the range of from 8.5 to about 9.5. Alternatively, the pH of the aqueous phase can be monitored (continuously or at periodic time intervals) during the extraction and base can be added as needed to maintain the pH at a desired value. Desirably, the aqueous alkaline wash should be a food grade reagent. The defatted soy flake material should be contacted with sufficient wash solution to form a soy protein extract.

Whether a soy protein isolate or a soy protein concentrate is being produced, the weight ratio of wash solution to soy flake material may be from about 2:1 to about 20:1, and preferably is from about 5:1 to about 10:1. Preferably the soy flake material is agitated in the wash solution and then centrifuged for a period of time to facilitate removal of materials soluble in the wash solution from the soy flake material. The wash solution is then decanted from the soy flake material to provide the soy protein extract. The above described extraction removes soluble components of the soy protein-containing material.

Once the soy protein has been extracted, it may be suspended in a wash solution. Typically, the wash solution comprises water having a temperature of from about 90° F. to about 100° F. (about 32° C. to about 38° C.) for soy protein isolates and about 130° F. (about 54° C.) for soy protein concentrates. This water wash suspension further aids in removing water soluble components of the extracted soy protein.

The suspended soy protein may then be precipitated with an acid to form a precipitated soy protein curd. Precipitation separates remaining impurities, such as carbohydrates and fats, from the soy protein curd. In one embodiment, to allow for sufficient precipitation, the acid is contacted with the suspended soy protein for a time period of about 5 to 10 minutes. Typically, the precipitation of the soy protein curd is done at or near the isoelectric point of the soy proteins; that is, precipitation at a pH of from about 4.0 to about 5.0, preferably about 4.5. Suitable acids for precipitation can include, for example, hydrochloric acid, citric acid, phosphoric acid, and other organic and inorganic acids.

The above extraction, suspension, and precipitation steps can optionally be repeated one or more times to further remove impurities, such as carbohydrates and fat, from the precipitated soy protein curd.

After sufficient extraction and precipitation, the precipitated soy protein curd is typically contacted with a hydrating solution comprising water to form a precipitated soy protein curd suspension. Typically, the precipitated soy protein curd is contacted with the hydrating solution for about 5 minutes. Suitably, hydration occurs by contacting the precipitated soy protein curd with a sufficient amount of hydrating solution comprising water.

After the precipitated soy protein curd has been sufficiently hydrated, the precipitated soy protein curd suspension may be contacted with a basic solution, such as a sodium hydroxide solution, or another suitable basic solution to form a neutralized soy protein curd suspension or material. Typically, the precipitated soy protein curd suspension should be contacted with enough basic solution to raise the pH of the neutralized soy protein curd suspension or material to a pH of from about 6.5 to about 8.0, preferably about 6.8 to about 7.4. Increasing the pH of the precipitated soy protein curd suspension to a neutral pH is desirable as it has been found that the soy protein isolates and soy protein concentrates described herein have improved flavor when dried at a neutral pH.

The processes for making the soy protein isolates and soy protein concentrates for use in the processes of the present invention may further include a heat treatment. Heating can be carried out prior to, or after, the pH is adjusted to a neutral pH. The heat treatment acts to pasteurize or sterilize the soy protein curd suspension or material. Typically, the heat treatment comprises heating at a temperature of from about 30° C. to about 100° C. and a pressure of 500 psig for from about 1 to 30 seconds, preferably for a period from about 5 to 10 seconds.

The neutralized, heat treated soy protein curd suspension may then be dried. In one embodiment, drying may be done by spray drying at an inlet temperature of from about 176.7° C. to about 343.3° C., more typically from about 204.4° C. to about 260° C., and at an exhaust temperature of from about 180° F. to about 210° F., and more typically from about 90.6° C. to about 96.1° C. Alternatively, the neutralized, heat treated soy protein curd suspension can be freeze dried, or dried in another conventional manner.

Optionally, commercially available intact soy protein concentrates or intact soy protein isolates may be used as the plant protein material in the processes described herein. Examples of suitable commercially available intact soy protein concentrates are Alpha™ 5812 and Alpha™ 5800, both of which are commercially available from The Solae Company (St. Louis, Mo.). Particularly preferred is Alpha™ 5812, which is an extracted soy protein concentrate comprising at least about 76% (by weight dry concentrate) protein. In addition to the protein, Alpha™ 5812 includes less than about 10% (by weight concentrate) carbohydrates; less than about 0.9% (by weight concentrate) fat; less than about 8% (by weight concentrate) ash; and about 6% (by weight concentrate) moisture. Examples of suitable commercially available intact soy protein isolates are Supro® 760, Supro® 500E, EX32, Supro® Plus 651, all of which are commercially available from The Solae Company (St. Louis, Mo.). Supro® 760 is particularly preferred. Specifically, Supro® 760 is an extracted soy protein isolate comprising 90% (by weight dry isolate) protein. In addition to the protein, Supro® 760 includes less than about 1.0% (by weight isolate) fat; less than about 4.5% (by weight isolate) ash; and less than about 5.5% (by weight isolate) moisture.

When soy protein isolates are being produced, suitable precipitated soy protein curds comprise at least about 90% (by weight dry basis) soy protein. More suitably, the precipitated soy protein curd comprises from about 90% (by weight dry basis) to about 95% (by weight dry basis) soy protein. When soy protein concentrates are being produced, the suitable precipitated soy protein curd comprises from about 60% (by weight dry basis) to less than 90% (by weight dry basis) soy protein. More suitably, the precipitated soy protein curd comprises about 70% (by weight dry basis) soy protein.

Once the plant protein material is sufficiently hydrated to form an acidic, protein-containing solution, the acidic, protein-containing solution is subjected to a heat treatment. The heat treatment typically eliminates any microbial contamination of the acidic, protein-containing solution and further can enable storage stability of the solution. The acidic, protein-containing solution (or the enzyme treated acidic, protein-containing solution as discussed below) is heated to a temperature of from about 85° C. to about 95° C. More suitably, the acidic, protein-containing solution is heated to a temperature of from about 85° C. One suitable method of heating the acidic, protein-containing solution is by using ultra-high temperature (UHT) heat treatment equipment. Suitable examples of UHT heat treatment equipment for use in the heat treatment are hydro heaters, microwave heaters, and thermo screws, all available from Micro Thermics, Inc. (Raleigh, N.C.) and Tetra Pak (Switzerland).

The acidic, protein-containing solution is held at the heated temperature for a period of from about 30 seconds to about 50 minutes to form the acidic, protein-containing drink. More suitably, the acidic, protein-containing solution is held at the heated temperature for a period of about 5 minutes.

As noted above, in one embodiment, after the plant protein material has been sufficiently hydrated to form the acidic, protein-containing solution and prior to the heat treatment, an enzyme is introduced into the acidic, protein-containing solution. A preferred enzyme for introduction into the acidic, protein-containing solution is a phytic acid degrading enzyme. Phytic acid is a common name for myo-inositol hexaphosphate, and is naturally found in plant protein materials, such as soy proteins, and can reduce the functionality (e.g., solubility) of the plant protein material when used in foods and food products, especially at a low pH. As used herein, the term “phytic acid” is meant to include not only free phytic acid, but also molecular complexes of phytic acid with other plant protein material constituents, as well as salts and esters of phytic acid, including phytate (a free salt or ester of phytic acid) and phytin (the calcium magnesium salt of phytic acid). Generally, treatment with a phytic acid degrading enzyme reduces the amount of phytic acid present in the plant protein material of the acidic, protein-containing solution by hydrolyzing the phytic acid and releasing various nutrients that may be complexed with the phytic acid, resulting in a plant protein material with a reduced amount of phytic acid.

It is generally desirable to use a phytic acid degrading enzyme with low or no protease activity to reduce the likelihood of substantial hydrolysis of the protein, which can result in reduced functionality. Thus, the phytic acid degrading enzyme used in the processes of the present invention will desirably not substantially hydrolyze the plant protein material in the acidic, protein-containing drink, as a high level of hydrolysis can lower the functional properties of the acidic, protein-containing drink including, for example, gel forming capability, deterioration of taste due to an increase in low molecular weight hydrolysates, and the like.

The origin of the phytic acid degrading enzyme is not specifically limited so long as it has a sufficient phytic acid-hydrolyzing activity to be beneficial. Phytic acid degrading enzymes include phytase and acid phosphatases. Phytase and acid phosphatases are produced by various microorganisms such as Aspergillus spp., Rhizopus spp., and yeasts, as well as various plant seeds, such as wheat, during germination. Enzyme preparations can be obtained from these organisms using methods known in the art. Generally, a phytic acid degrading enzyme derived from a microorganism is more advantageous than one derived from a plant due to its higher phytic acid-hydrolyzing activity and a lower coexisting protease activity. Particularly preferred enzymes are sold under the trademark Finase® S40 (Alko Ltd., Helsinki, Finland), Amano 3000 (Amano Pharmaceutical Co., LTD, Nagoya, Japan), Natuphos® Phytase (BASF corp., Wyandotte, Mich.), and Novozymes Phytase (Batch NS37032 from Novozymes A/S, Bagsvaerd, Denmark).

The amount of phytic acid degrading enzyme used in the processes of the present invention should be sufficient to achieve the desired level of phytic acid degradation; that is, the amount of phytic acid degrading enzyme should be sufficient to produce an end product with a desired level of phytic acid. The amount of phytic acid degrading enzyme typically depends on the amount of time the enzyme is allowed to react with the acidic, protein-containing solution. It has been discovered that it is particularly advantageous to react the enzyme with the acidic, protein-containing solution for a period of from about 1 minute to about 60 minutes, and preferably for about 25 minutes to produce an enzyme treated acidic, protein-containing solution with high functionality and good sensory characteristics. Optionally, the enzyme and acidic, protein-containing solution may be mixed to facilitate reaction.

Typically, when the phytic acid degrading enzyme is reacted with the acidic, protein-containing solution for a period of about 25 minutes, the phytic acid degrading enzyme is introduced into the acidic, protein-containing solution in an amount of about 50 Kilo Phytase Units (KPU) (per gram plant protein material) to about 100 KPU (per gram plant protein material).

The enzyme is preferably reacted with the acidic, protein-containing solution at a temperature and a pH that are conducive to activity of the enzyme. For example, in one embodiment, the enzyme may be reacted at a temperature of from about 20° C. to about 70° C., and at a pH of from about 1.0 to 4.5. It is noted, however, that the enzyme does not have to be contacted with the acidic, protein-containing solution under these pH or temperature conditions. Rather, it is possible to contact the acidic, protein-containing solution with the enzyme during a stage in processing at which the pH and/or temperature fall outside of optimal ranges. In such an instance, the enzyme will begin to have an effect at later stages of processing when the pH and temperature conditions fall within a range conducive to activity of the enzyme. In this embodiment, once the reaction time is complete, the enzyme treated acidic, protein-containing solution is subjected to the heat treatment described herein above to stop the enzymatic reaction.

When the optional enzyme treatment is used to produce the acidic, protein-containing drinks, the process can further include adding a mouthfeel modifying agent to the acidic beverage prior to pH adjustment. Typically, the mouthfeel modifying agent improves mouthfeel by interfering with the interaction between food proteins and the surface cells of the cheeks. Suitable mouthfeel modifying agents can include pectin, dextrin-containing polysaccharide hydrolysates, agar, carrageenan, maltodextrins, FiberSol® (available from Matsutani America, Inc., Decatur, Ill.), tagatose, polydextrose, tamarind seed polysaccharides, angelica gum, karaya gum, xanthan gum, sodium alginate, tragacanth gum, guar gum, locust bean gum, pullulan, jellan gum, gum arabic and modified gum arabic, carboxymethylcellulose, propylene glycol alginate ester, natural or chemically modified lecithins, glyceryl ester of fatty acids, diacetyl tartaric ester or monoglycerides, sodium stearoyl lactate, polysorbates, and combinations thereof.

Suitably, the mouthfeel modifying agents can be added in the amount of from about 0.01% (by weight acidic beverage) to about 15% (by weight acidic beverage). More suitably, the mouthfeel modifying agents can be added in the amount of from about 0.01% (by weight acidic beverage) to about 10% (by weight acidic beverage), and even more suitably, in the amount of from about 0.01% (by weight acidic beverage) to about 5.0% (by weight acidic beverage). As substantially no mouthfeel modifying agent is lost during hydration, enzyme treatment, heat treatment, or other processing, the acidic, protein-containing drink will comprise from about 0.01% (by weight) to about 15% (by weight) mouthfeel modifying agent. More suitably, the acidic, protein-containing drink will comprise from about 0.01% (by weight) to about 10% (by weight) mouthfeel modifying agent, and even more suitably, from about 0.01% (by weight) to about 5.0% (by weight) mouthfeel modifying agent.

Once the acidic, protein-containing drink is produced, the processes described in the present invention can further include homogenizing the acidic, protein-containing drink to help uniformly disperse the proteins in the acidic, protein-containing drink. Specifically, this homogenization allows for the acidic, protein-containing drink to have more uniform particle sizes. Suitably, the acidic, protein-containing drink can be homogenized in a 2-stage homogenization process. In the first stage the acidic, protein-containing drink is homogenized at a homogenization pressure of from about 1000 psi to about 14,500 psi and at a temperature of from about 65° C. to about 80° C. In the second stage, the acidic, protein-containing drink can be homogenized at a homogenization pressure of about 500 psi and at a temperature of from about 65° C. to about 80° C.

Additionally, the acidic, protein-containing drink produced in the processes above can optionally be cooled to room temperature (i.e., about 25° C.) after heat treatment for easier packaging, storage, and transportation. Cooling will also better maintain the drinking quality and maximize flavor retention of the acidic, protein-containing drink. In one embodiment, the acidic, protein-containing drink is hot packed for storage and transportation. Specifically, in this embodiment, the temperature of the acidic, protein-containing drink is raised to a temperature of about 87° C. and maintained at that temperature for about 2 minutes prior to packaging. The acidic, protein-containing drink is then packaged and left hot for another 2 minutes prior to cooling by ice water spray or ice bath to a temperature of about 25° C.

In another embodiment, the acidic, protein-containing drink can be cooled to a temperature of about 25° C. after heat treatment by a tube heat-exchange cooling method. The cooling can suitably be performed using a tube heat-exchange cooling method wherein the liquid is under a pressure of about 100 psi.

In addition to the homogenizing and cooling, the processes for producing the acidic, protein-containing drink can further include adjusting the pH of the acidic, protein-containing drink to a pH of from about 2.0 to about 5.0, more suitably to a pH of from about 3.0 to about 5.0, even more suitably to a pH of from about 3.5 to about 5.0, and even more suitably to a pH greater than 3.7 to about 5.0. When the pH of the acidic, protein-containing drink is higher than the preferred pH range of about 2.0 to about 5.0, a suitable organic or inorganic acid can be used to adjust the pH. One suitable acid for lowering the pH of the acidic, protein-containing drink is 50% citric acid. When the pH of the acidic, protein-containing drink is lower than the preferred pH range of about 2.0 to about 5.0, a suitable base can be used to adjust the pH. One suitable base for raising the pH of the acidic, protein-containing drink is 45% potassium hydroxide.

The acidic, protein-containing drinks produced by the processes of the present invention typically include from about 0.05% (by weight) to about 10% (by weight) plant protein material. More suitably, the acidic, protein-containing drinks produced by the processes of the present invention include from about 1.2% (by weight) to about 5.0% (by weight) plant protein material.

Additionally, the acidic, protein-containing drinks produced by the above processes have a pH of from about 2.0 to about 5.0. Suitably, the acidic, protein-containing drinks produced by the above processes have a pH of from about 3.0 to about 5.0, more suitably a pH of from about 3.5 to about 5.0, and even more suitably a pH greater than 3.7 to about 5.0.

In one embodiment, when the acidic, protein-containing drink is produced using the process including an enzyme treatment, the acidic, protein-containing drink further includes a mouthfeel modifying agent. Suitably mouthfeel modifying agents can include pectin, dextrin-containing polysaccharide hydrolysates, agar, carrageenan, maltodextrins, FiberSol® (available from Matsutani America, Inc., Decatur, Ill.), tagatose, polydextrose, tamarind seed polysaccharides, angelica gum, karaya gum, xanthan gum, sodium alginate, tragacanth gum, guar gum, locust bean gum, pullulan, jellan gum, gum arabic and modified gum arabic, carboxymethylcellulose, propylene glycol alginate ester, natural or chemically modified lecithins, glyceryl ester of fatty acids, diacetyl tartaric ester or monoglycerides, sodium stearoyl lactate, polysorbates, and combinations thereof.

Suitably, as noted above, the acidic, protein-containing drinks can include a mouthfeel modifying agent in an amount of from about 0.01% (by weight) to about 15% (by weight). More suitably, the acidic, protein-containing drinks can include a mouthfeel modifying agent in an amount of from about 0.01% (by weight) to about 10% (by weight), and more suitably, from about 0.01% (by weight) to about 5.0% (by weight).

When the acidic, protein-containing drink is produced using the process of the present invention without an enzyme treatment, the acidic, protein-containing drink is substantially free of a mouthfeel modifying agent. As used herein, “substantially free of a mouthfeel modifying agent” means the acidic, protein-containing drink comprises less than 0.01% (by weight) mouthfeel modifying agent, and more suitably, 0% (by weight) mouthfeel modifying agent.

The acidic, protein-containing drinks of the present invention can optionally include other ingredients. Suitably optional ingredients for use with the acidic, protein-containing drink can include, for example, fats, additional flavoring agents, coloring agents, nutrients, minerals, vitamins, sweeteners, and combinations thereof at their art-established acceptable amounts. For example, when the consumer wants an acidic, protein-containing drink with a creamier texture, the acidic, protein-containing drink optionally includes fat in an amount of from about 0.1% (by weight acidic beverage) to about 5.0% (by weight acidic beverage). Suitable fat can include vegetable oils such as sunflower oil, safflower oil, peanut oil, canola oil, olive oil, and combinations thereof.

As a result of the above processes, the acidic, protein-containing drinks have improved functionality. Specifically, the acidic, protein-containing drinks have a reduced viscosity, which is a highly desirable characteristic for acidic beverages. As used herein, the term “viscosity” means the apparent viscosity of the acidic, protein-containing drink as measured at 25° C. with a rotating spindle viscometer utilizing a large annulus. A suitable rotating spindle viscometer is a Brookfield viscometer.

Suitably, the acidic, protein-containing drinks produced by the above processes have a viscosity (at 10% solids basis) at room temperature (about 25° C.) of from about 1.0 centipoise to about 10 centipoise. More suitably, the acidic, protein-containing drinks have a viscosity (at 10% solids basis) at a temperature of about 25° C. of from about 2.0 centipoise to about 8.0 centipoise, and even more suitably, a viscosity (at 10% solids basis) at a temperature of about 25° C. of from about 3.0 centipoise to about 5.0 centipoise. At these viscosity levels, the plant protein material is sufficiently soluble to provide excellent mouthfeel.

In addition to the reduced viscosity, the acidic, protein-containing drinks produced by the processes of the present invention have an improved sedimentation rate; that is, the rate at which sedimentation or precipitation forms in the drink is significantly slowed as compared to conventional acidic, protein-containing drinks. Sedimentation rate may be measured as the percentage of sedimentation over time, suitably days. One suitable method for calculating the percentage of sedimentation is includes pouring a sample of an acidic, protein-containing drink into a 250-milliliter graduated cylinder and letting the sample stand for a period of days and at discreet time intervals maybe, for example, 30 days, 60 days, 90 days, and 120 days. After 30 days, the percentage of sedimentation of the acidic, protein-containing drink is determined by measuring the height of the sediment (millimeters) and the height of the total acidic, protein-containing drink sample (millimeters). The height of the sediment is then divided by the height of the total beverage and the answer is then multiplied by 100.

The sedimentation rate of the acidic, protein-containing drink will generally depend upon the amount of protein in the drink. Suitably, the acidic, protein-containing drink will have a sedimentation rate of less than about 10% sedimentation at day 30, more suitably less than about 6% sedimentation at day 30, even more suitably less than about 3% sedimentation at day 30, even more suitably less than about 2% sedimentation at day 30, and even more suitably less than about 1% sedimentation at day 30. More suitably, the acidic, protein-containing drink will have a sedimentation rate of less than about 10% sedimentation at day 45, even more suitably less than about 6% sedimentation at day 45, even more suitably less than about 3% sedimentation at day 45, even more suitably less than about 2% sedimentation at day 45, and even more suitably less than about 1% sedimentation at day 45.

The acidic, protein-containing drinks made according to the processes of the present invention can further have a shorter shake back time as compared to acidic, protein-containing drinks made using conventional processes. The shake back time of an acidic, protein-containing drink is used to determine if the acidic, protein-containing drink has a hard pack sediment or soft pack sediment. Specifically, if sediment is hard pack, the sediment is hard to shake back into suspension. If the sediment is soft pack, the sediment is easy to shake back into suspension. As such, the shake back time will be longer for a hard pack sediment than for a soft pack sediment.

The above described reduced viscosity and improved sedimentation rate of the acidic, protein-containing drinks produced in the present invention result in the acidic, protein-containing drinks having an improved mouthfeel. Specifically, the acidic, protein-containing drinks have a more uniform, thinner more homogeneous mouthfeel.

Processes For Producing Soy Protein Materials With Low Phytic Acid Contents

Suitable soy protein materials for use in food products include soy flakes, soy flour, soy grits, soy meal, soy protein concentrates, soy protein isolates, and mixtures thereof. The primary difference between these soy protein materials is the degree of refinement relative to whole soybeans.

Soy flakes are generally produced by dehulling, defatting, and grinding the soybean and typically contain less than about 60% (by weight) soy protein on a moisture-free basis. Soy flakes also contain soluble carbohydrates, insoluble carbohydrates such as soy fiber, and fat inherent in soy. Soy flakes may be defatted, for example, by extraction with hexane. Soy flours, soy grits, and soy meals are produced from soy flakes by comminuting the flakes in grinding and milling equipment such as a hammer mill or an air jet mill to a desired particle size. The comminuted materials are typically heat treated with dry heat or steamed with moist heat to “toast” the ground flakes and inactivate anti-nutritional elements present in soy such as Bowman-Birk and Kunitz trypsin inhibitors. Heat treating the ground flakes in the presence of significant amounts of water is avoided to prevent denaturation of the soy protein in the material and to avoid costs involved in the addition and removal of water from the soy material. The resulting ground, heat treated material is a soy flour, soy grit, or a soy meal, depending on the average particle size of the material. Soy flour generally has a particle size of less than about 150 sum. Soy grits generally have a particle size of about 150 to about 1000 μm. Soy meal generally has a particle size of greater than about 1000 μm.

Soy protein concentrates typically contain about 60% (by weight) to less than 90% (by weight) soy protein on a moisture free basis, with the major non-protein component being fiber. Soy protein concentrates are typically formed from defatted soy flakes by washing the flakes with either an aqueous alcohol solution or an acidic aqueous solution to remove the soluble carbohydrates from the protein and fiber.

Soy protein isolates, which are more highly refined soy protein materials, are processed to contain at least 90% (by weight) soy protein on a moisture free basis and little or no soluble carbohydrates or fiber. Soy protein isolates are typically formed by extracting soy protein and water soluble carbohydrates from defatted soy flakes or soy flour with an aqueous extractant. The aqueous extract, along with the soluble protein and soluble carbohydrates, is separated from materials that are insoluble in the extract, mainly fiber. The extract is typically then treated with an acid to adjust the pH of the extract to the isoelectric point of the protein to precipitate the protein from the extract. The precipitated protein is separated from the extract, which retains the soluble carbohydrates, and is dried after an optional pH adjustment step.

In one embodiment, the soy protein products of the present invention may comprise a soy protein isolate, a soy protein concentrate, or a combination that has been treated during processing with a phytic acid degrading enzyme. Depending upon the specific process employed, the soy protein products may be treated with a phytic acid degrading enzyme at several different points during processing, as discussed below. The resulting soy protein products comprise from greater than 0% to about 1.3% (by weight total solids), and preferably about 0.1% to about 1.3% (by weight total solids) phytic acid, and have good suspendability, stability, and flavor when used in acidic drinks.

In general, methods for producing soy protein isolates and soy protein concentrates comprise: 1) preparing a soy protein extract from a soy protein-containing plant material, such as soy flakes or soy flour; 2) contacting the soy protein extract with an acid to form a soy protein precipitate; 3) optionally contacting the soy protein precipitate with a hydrating solution comprising water, for example, to form a soy protein suspension; and 4) drying the soy protein precipitate or the soy protein suspension to form the soy protein isolate or soy protein concentrate.

Extraction processes and processes for forming soy protein curds are well known in the art, and any such process may be used herein to produce a soy protein precipitate or a soy protein curd. One example of a suitable process for preparing soy protein curds includes cracking soybeans to remove the hull, rolling them into flakes with flaking machines, defatting the flakes with hexane or heptane, subjecting the flakes to an oil extraction process, suspending the oil extracted flakes in a wash solution, drying the defatted flakes, and preparing a soy protein curd therefrom. Suitable flaking machines may consist of a pair of horizontal counter-rotating smooth steel rolls. The rolls are pressed one against the other by means of heavy springs or by controlled hydraulic systems. The soybeans are fed between the rolls and are flattened as the rolls rotate one against the other. The roll-to-roll pressure can be regulated to determine the average thickness of the flakes. The rolling process disrupts the oil cell, facilitating solvent extraction of the oil. Specifically, flaking increases the contact surface between the oilseed tissues and the extractant, and reduces the distance that the extractant and the extract will have to travel in the extraction process as described herein below. Typical values for flake thickness are in the range of 0.2 to 0.35 millimeters. The defatted soy flake material may then be used to produce a soy protein isolate or a soy protein concentrate.

When a soy protein concentrate is being produced, the defatted soy flake material may then be put through a solvent extraction process. Typically, the solvent for the extraction process is an aqueous acid or alcohol wash. The aqueous acid or alcohol wash removes materials soluble therein, including a substantial portion of the soluble carbohydrates. Typically, the weight ratio of wash solution to soy flake material may be from about 2:1 to about 20:1, and preferably is from about 5:1 to about 10:1, with the wash solution having a temperature of from about 120° F. to about 135° F. This produces a protein concentrate material that contains from about 60% to less than 90% protein by weight on a dry basis.

Alcohol extraction to remove alcohol soluble components from the protein is particularly preferred in the solvent extraction process since alcohol extraction generally produces a better tasting soy protein material compared to aqueous acid extraction. This type of extraction is based on the ability of the wash solvent solutions to extract the soluble sugar/carbohydrate fraction of the defatted soy flake without solubilizing its proteins. A suitable alcohol solvent is an aqueous solution of lower aliphatic alcohols, such as, methanol, ethanol, and isopropyl alcohol. Typically, the alcohol wash should be a food grade reagent, and preferably is an aqueous ethanol solution. An aqueous ethanol solution may contain from about 55% to about 90% ethanol by volume.

The soy protein present in the insoluble fiber fraction may then be precipitated with an acid to form a soy protein precipitate. Precipitation separates remaining impurities, such as soluble carbohydrates and fats, from the soy protein. In one embodiment, to allow for sufficient precipitation, the acid is contacted with the soy protein extract for a time period of about 5 to 10 minutes. Typically, the precipitation of the soy protein is done at or near the isoelectric point of the soy proteins; that is, precipitation at a pH of from about 4.0 to about 5.0, preferably about 4.5. Suitable acids for precipitation can include, for example, hydrochloric acid, citric acid, phosphoric acid, and other organic and inorganic acids. The above extraction and precipitation steps can optionally be repeated one or more times to further remove impurities, such as carbohydrates and fat, from the soy protein precipitate. When soy protein concentrates are being produced, the soy protein precipitate comprises from about 60% (by weight dry basis) to less than 90% (by weight dry basis) soy protein. More suitably, the soy protein precipitate comprises about 70% (by weight dry basis) soy protein.

When a soy protein isolate is being produced, the defatted soy flake material, described above, may be put through an aqueous extraction process. Typically, the aqueous extraction process is an aqueous alkaline procedure. The aqueous alkaline procedure separates materials insoluble therein, including a substantial portion of the insoluble carbohydrates. After further processing, described below, this produces a protein material that contains at least about 90% protein by weight on a dry basis.

Typically, the alkaline wash has a pH of from 8.5 to about 10. The extraction is generally conducted by contacting the defatted soy flakes with an aqueous solution containing a set amount of base, such as sodium hydroxide, potassium hydroxide, ammonium hydroxide and/or calcium hydroxide, and allowing the pH to slowly decrease as the base is neutralized by substances extracted out of the solid soy flakes. The initial amount of base is typically chosen so that at the end of the extraction operation the extract has a desired pH value, e.g., a pH within the range of from 8.5 to about 9.5. Alternatively, the pH of the aqueous phase can be monitored (continuously or at periodic time intervals) during the extraction and base can be added as needed to maintain the pH at a desired value. Desirably, the aqueous alkaline wash should be a food grade reagent. The defatted soy flake material should be contacted with sufficient wash solution to form a soy protein extract.

Typically, the weight ratio of wash solution to soy flake material is from about 2:1 to about 20:1, and preferably is from about 5:1 to about 10:1, with the wash solution having a temperature of from about 70° F. to 130° F. (21.1-54.4° C.), typically from about 90° F. to 100° F. (32.2-37.8° C.). Preferably the soy flake material is agitated in the wash solution for from about 10 to about 15 minutes, and then centrifuged for a period of time to facilitate removal of insoluble materials, such as fibers, from the soy flake material. The wash solution is then decanted from the soy flake material to provide a soy protein extract. This process may optionally be repeated on the insoluble materials removed during the production of the first soy protein extract to produce a second soy protein extract. This second soy protein extract may then be combined with the first soy protein extract and the combined soy protein extract centrifuged to produce a clarified soy protein extract.

The soy protein present in the extract may then be precipitated with an acid to form a soy protein precipitate. As discussed above, precipitation separates additional impurities, such as soluble carbohydrates and fats, from the soy protein. The soy protein may be precipitated under the conditions as described above for the production of concentrates.

At this point, the soy protein precipitate typically comprises less than 90% protein by weight. Thus, the above extraction and precipitation steps can optionally be repeated one or more times to further remove impurities, such as carbohydrates and fat, from the soy protein precipitate. In addition, when soy protein isolates are being produced, the soy protein precipitate may be subjected to further washing and concentration to produce a soy protein curd having at least 90% (by weight dry basis) soy protein. For example, the precipitate may be continuously washed and centrifuged by adding water continuously to the precipitate using a ratio of water to precipitate of about 1:1 to about 6:1, more typically about 4:1, at a temperature of from about 70° F. to 130° F. (21.1-54.4° C.), typically from about 90° F. to 100° F. (32.2-37.8° C.), and centrifuging. Typically during this process, approximately ⅓ of the resulting suspension is recycled back into the centrifuge for further centrifugation, and approximately ⅔ is separated for further concentration. The portion to be concentrated is typically contacted with water at a ratio of about 3:1 to about 9:1, typically about 7:1 at a temperature of from about 70° F. to 130° F. (21.1-54.4° C.), typically from about 90° F. to 100° F. (32.2-37.8° C.), followed by heating with steam to about 130° F. to about 140° F. (54.4-60.0° C.), typically about 135° F. (57.2° C.), and further centrifuged to concentrate the protein. The resulting insoluble material is diluted with water to produce a soy protein curd. Typically, the soy protein curd will have about 25% to 35% total solids. When soy protein isolates are being produced, suitable soy protein curds comprise at least about 90% (by weight dry basis) soy protein. More suitably, the soy protein curd comprises from about 90% (by weight dry basis) to about 95% (by weight dry basis) soy protein.

Optionally, commercially available soy protein concentrates or soy protein isolates may also be used in the processes described herein. One example of a suitable commercially available soy protein concentrate is Procon 2000, commercially available from The Solae Company (St. Louis, Mo.). Procon 2000 is an alcohol extracted soy protein concentrate comprising 70% (by weight concentrate) soy protein; 18% (by weight concentrate) carbohydrates; 1% (by weight concentrate) fat; 6% (by weight concentrate) ash; and 5% (by weight concentrate) moisture.

After sufficient extraction, precipitation, and concentration, the soy protein precipitate or the soy protein curd is typically contacted with a hydrating solution comprising water to form a soy protein suspension. As used herein, the term “hydrating” refers to a static or dynamic soaking of the soy protein precipitate or the soy protein curd to introduce water therein. Suitably, hydration occurs by contacting the soy protein precipitate or soy protein curd with a sufficient amount of hydrating solution comprising water. The resulting soy protein suspension typically comprises from about 10% to about 16% total solids, and more typically about 12% total solids.

After the soy protein precipitate or the soy protein curd has been sufficiently hydrated, the soy protein suspension may be contacted with a basic solution, such as a sodium hydroxide solution, or another suitable basic solution to form a neutralized soy protein suspension or material. Typically, the soy protein suspension should be contacted with enough basic solution to raise the pH of the neutralized soy protein suspension or material to a pH of from about 6.5 to about 8.0, preferably about 6.8 to about 7.4. Increasing the pH of the soy protein suspension to a neutral pH is desirable as it has been found that drying the soy protein products of the present invention at a neutral pH may improve the flavor of the soy protein product, as discussed below.

The processes for making the soy protein products of the present invention may further comprise a heat treatment to pasteurize or sterilize the soy protein suspension or material. Typically, the heat treatment is performed after the soy protein suspension is neutralized. Heat treatment generally comprises heating at a temperature of from about 265° F. to about 325° F. (about 129.4° C. to about 162.7° C.), and more typically from about 269.6° F. to about 320.0° F. (132-160° C.), and a pressure of from about 50 to 100 psig for from about 1 to 30 seconds, preferably for from about 5 to 10 seconds. Following heat treatment, the heat treated soy protein material is typically flash cooled in a vacuumizer to a temperature of from about 125° F. (51.6° C.) to about 200° F. (93.3° C.), and more typically from about 125° F. (51.6° C.) to about 140° F. (60° C.). In some embodiments, additional heat treating may be performed before and/or after contacting the soy protein material with a phytic acid degrading enzyme to, for example, stop the degradation of phytic acid by the phytic acid degrading enzyme. Such heat treatment is discussed below.

The neutralized, heat treated soy protein material may then be dried. In one embodiment, drying may be done by spray drying at an inlet temperature of from about 350° F. to about 650° F. (167.7-343.3° C.), more typically from about 400° F. to about 500° F. (204.4-260.0° C.), and at an exhaust temperature of from about 180° F. to about 210° F. (82.2-98.9° C.), and more typically from about 195° F. to about 205° F. (90.6-96.1° C.). Alternatively, the neutralized, heat treated soy protein material can be freeze dried, or dried in another conventional manner.

Treatment with a Phytic Acid Degrading Enzyme

Phytic acid is a common name for myo-inositol hexaphosphate, and is naturally found in soy proteins and can reduce the functionality (e.g., solubility, suspendability) of the soy protein when used in foods and food products, especially at low pH. As used herein, the term “phytic acid” is meant to include not only free phytic acid, but also molecular complexes of phytic acid with other soybean constituents, as well as salts and esters of phytic acid, including phytate (a free salt or ester of phytic acid) and phytin (the calcium magnesium salt of phytic acid). Depending on the specific process employed, the soy protein isolates and soy protein concentrates of the present invention may be treated at several different points during processing with a phytic acid degrading enzyme. Treatment with a phytic acid degrading enzyme reduces the amount of phytic acid present in the soy protein products by hydrolyzing the phytic acid into its breakdown products, and in the process, releasing from the soy protein composition various micronutrients (such as minerals) and soy protein molecules that may be complexed with the phytic acid, resulting in a soy protein product with a reduced amount of phytic acid.

It is generally desirable to use a phytic acid degrading enzyme with low or no protease activity to reduce the likelihood of substantial hydrolysis of the protein, which can result in altered functionality of the intact soy protein composition. Thus, the phytic acid degrading enzyme used in the processes of the present invention will desirably not substantially hydrolyze the soy proteins, as hydrolysis can lower the functional properties of the soy protein including, for example, deterioration of taste due to an increase in low molecular weight hydrolysates.

The origin of the phytic acid degrading enzyme is not specifically limited so long as it has a sufficient phytic acid-hydrolyzing activity to be beneficial. Phytic acid degrading enzymes include phytase and acid phosphatases. Phytase and acid phosphatases are produced by various microorganisms such as Aspergillus spp., Rhizopus spp., and yeasts, as well as various plant seeds, such as wheat, during germination. Enzyme preparations can be obtained from these organisms using methods known in the art. Generally, a phytic acid degrading enzyme derived from a microorganism is more advantageous than one derived from a plant due to its higher phytic acid-hydrolyzing activity and a lower coexisting protease activity. Particularly preferred enzymes are sold under the trademark Finase® S40′ (Alko Ltd., Helsinki, Finland), Amano 3000 (Amano Pharmaceutical Co., LTD, Nagoya, Japan), Natuphos® Phytase (BASF corp., Wyandotte, Mich.), and Novozymes Phytase (Novozymes, Bagsvaerd, Denmark).

The processes of the present invention may include treatment of a soy protein material with a phytic acid degrading enzyme at various stages of the processing, depending on the specific process utilized. For example, in one embodiment, a phytic acid degrading enzyme is contacted with soy protein material after formation of a soy protein suspension, and before the pH of the suspension is adjusted to a neutral pH. Thus, one process of the present invention for producing a soy protein product comprises: preparing a soy protein extract from a soy protein-containing plant material; contacting the soy protein extract with an acid to form a soy protein precipitate; contacting the soy protein precipitate with a hydrating solution to form a soy protein suspension; introducing a phytic acid degrading enzyme into the soy protein suspension and reacting the soy protein suspension with the phytic acid degrading enzyme to form a modified soy protein material (i.e., a phytic acid degrading enzyme treated soy protein material); adjusting the pH of the modified soy protein material to a neutral pH to form a neutralized soy protein material; subjecting the neutralized soy protein material to a heat treatment to form a heat treated soy protein material; and drying the heat treated soy protein material to form the soy protein product.

In another embodiment, a phytic acid degrading enzyme is contacted with soy protein material after formation of a soy protein extract and before the soy protein extract is precipitated to form a soy protein precipitate. This process comprises: preparing a soy protein extract from a soy protein-containing plant material; introducing a phytic acid degrading enzyme into the soy protein extract and reacting the soy protein extract with the phytic acid degrading enzyme to form a modified soy protein extract (i.e., a phytic acid degrading enzyme treated soy protein extract); contacting the modified soy protein extract with an acid to form a modified soy protein precipitate (i.e., a phytic acid degrading enzyme treated soy protein precipitate); contacting the modified soy protein precipitate with a hydrating solution to form a modified soy protein suspension (i.e., a phytic acid degrading enzyme treated soy protein suspension); adjusting the pH of the modified soy protein suspension to a neutral pH to form a neutralized soy protein material; subjecting the neutralized soy protein material to a heat treatment to form a heat treated soy protein material; and drying the heat treated soy protein material to form the soy protein product.

In yet another embodiment, a phytic acid degrading enzyme is contacted with soy protein material after the pH of a soy protein suspension is adjusted to a neutral pH, and before the soy protein material is subjected to heat treatment and dried. This process comprises: preparing a soy protein extract from a soy protein-containing plant material; contacting the soy protein extract with an acid to form a soy protein precipitate; contacting the soy protein precipitate with a hydrating solution to form a soy protein suspension; adjusting the pH of the soy protein suspension to a neutral pH to form a neutralized soy protein material; introducing a phytic acid degrading enzyme into the neutralized soy protein material and reacting the neutralized soy protein material with the phytic acid degrading enzyme to form a modified soy protein material (i.e., a neutralized, phytic acid degrading enzyme treated soy protein material), wherein the pH of the modified soy protein material is neutral; subjecting the modified soy protein material to a heat treatment to form a heat treated soy protein material; and drying the heat treated soy protein material to form the soy protein product.

It is noted that the addition of a phytic acid degrading enzyme to the neutralized soy protein material may somewhat lower the pH of the neutralized soy protein material. Because, as discussed below, it is desirable to dry the soy protein material at a neutral pH, e.g., at a pH of from about 6.5 to about 8.0, it is therefore preferable that the pH of the neutralized soy protein material be sufficiently high that, upon introduction of the phytic acid degrading enzyme, the pH of the resulting modified soy protein material is still neutral, e.g., at a pH of from about 6.5 to about 8.0.

The amount of phytic acid degrading enzyme used in the processes of the present invention should be sufficient to achieve the desired level of phytic acid degradation; that is, the amount of phytic acid degrading enzyme should be sufficient to produce an end product with a desired level of phytic acid. Typically, the phytic acid degrading enzyme is used in an amount of about 0.01% to about 0.5% by weight total solids and preferably in an amount of about 0.05% to about 0.2% by weight total solids.

The phytic acid degrading enzyme is preferably reacted with the soy protein material at a temperature and a pH that are conducive to activity of the phytic acid degrading enzyme. As will be recognized by those skilled in the art, the specific conditions for reaction may vary depending on the enzyme used. In one embodiment, when the phytic acid degrading enzyme is phytase, the phytic acid degrading enzyme may be reacted at a temperature of from about 20° C. to about 70° C., and at a pH of from about 2.5 to 7.5. Thus, when phytase is the phytic acid degrading enzyme, it is generally preferable to heat the soy protein material to a temperature of from about 38° C. to about 60° C. prior to introducing the phytic acid degrading enzyme into the soy protein material. It is noted, however, that the phytic acid degrading enzyme does not have to be contacted with the soy protein under these pH or temperature conditions. Rather, it is possible to contact the soy protein with the phytic acid degrading enzyme during a stage in processing at which the pH and/or temperature fall outside of optimal ranges. In such an instance, the phytic acid degrading enzyme will begin to have an effect at later stages of processing when the pH and temperature conditions fall within a range conducive to activity of the phytic acid degrading enzyme.

Following reaction of the soy protein material with the phytic acid degrading enzyme, the treated (i.e., the modified) soy protein material is typically heated to stop the activity of the phytic acid degrading enzyme. For example, the modified (i.e., phytic acid degrading enzyme treated) soy protein material may be heated to a temperature of from about 82° C. to about 94° C. to stop the phytic acid degrading enzyme activity. This heating step may occur in addition to the heat treatment (pasteurization) step, discussed above, or alternately, the pasteurization heat treating may act to stop the activity of the phytic acid degrading enzyme, when treatment with the phytic acid degrading enzyme occurs directly prior to pasteurization.

The phytic acid degrading enzyme may be reacted with the soy protein material for from about 30 seconds to about 120 minutes, and preferably for less than 60 minutes. It has been discovered that it is particularly advantageous to react the phytic acid degrading enzyme with the soy protein material for from about 30 seconds to about 50 minutes, and preferably for about 30 minutes to produce a soy protein product with good functionality. Optionally, the phytic acid degrading enzyme and soy protein material may be mixed to facilitate reaction. Once the reaction time is complete, the phytic acid degrading enzyme-treated soy protein material is subjected to a heat treatment as described herein to stop the enzymatic reaction.

As noted herein, the enzyme and heat treated soy protein material may be dried, for example, by spray drying. Advantageously drying occurs at a neutral pH, e.g., a pH of from about 6.5 to about 8.0, preferably about 6.8 to about 7.4. Drying at a neutral pH may improve the flavor attributes of the soy protein product, particularly those flavor attributes that impact astringent taste, and may result in a soy protein product with an improved taste as compared to other soy protein products that have been treated with a phytic acid degrading enzyme, as discussed herein.

The processes of the present invention described herein produce a soy protein product that has from greater than 0% to about 1.3% (by weight total solids) phytic acid, and more typically from about 0.1% to about 1.3% (by weight total solids) phytic acid according to Official Methods of Analysis of the AOAC (1995) 16th Ed., Method 986.11, Locator #32.5.18. Although removal of phytic acid from soy protein products is discussed herein primarily in terms of treatment of soy protein products during processing with a phytic acid degrading enzyme, other methods of reducing phytic acid content are known in the art and may be used in the methods described herein, to produce the low phytic acid soy protein products of the present invention. For example, various other methods of reducing phytic acid levels are known, including techniques using varying precipitation, extraction, and wash conditions, ion exchange, and ultrafiltration, among others. Genetic methods, such as production of soy plants that have been genetically modified to have a lower phytic acid content, may also be used. Regardless of how the phytic acid is removed, the soy protein isolates of the present invention preferably comprise from greater than 0% to about 1.3% (by weight total solids) phytic acid, more preferably from about 0.1% to about 1.3% (by weight total solids) phytic acid, and more preferably from greater than about 1% to about 1.3% (by weight total protein) phytic acid. The soy protein concentrates of the present invention preferably comprise greater than 0% to about 1.3% (by weight total solids) phytic acid, more typically from about 0.1% to about 1.3% (by weight total solids) phytic acid.

The soy protein products have excellent functionality when utilized in an acidic environment, such as in an acidic drink, where the pH is from about 2.5 to about 4.1, and more preferably from about 3.2 to about 3.8. The soy protein products have improved solubility, translucency, suspendability, and stability as compared to conventionally prepared soy protein products in acidic environments, and do not produce significant sedimentation over an extended period of time. In addition, the soy protein products produced by the processes described herein may have improved flavor and a reduced astringent taste, as compared to other soy protein products.

Sedimentation rate of the soy protein products in water having an acidic pH may be measured as the percentage of sedimentation over time. One suitable method for calculating the percentage of sedimentation of the soy protein products in an acidic drink is by using the following method: Make a 5% (by weight) soy protein product sample in 200 ml of deionized or distilled water that has been heated to 191° F. (88.3° C.). Optionally, 3-5 drops of defoamer (e.g. Pegosperse) and 3-6 drops of food dye (e.g. 1% FD&C Blue #1) may also be added. The pH of the sample is adjusted to a pH of 3.8 using an acid, such as hydrochloric acid, and the sample is then allowed to equilibrate for 30 minutes. The resulting sample is poured into a graduated cylinder and allowed to stand for a period of about 24 hours. After 24 hours, the percentage of sedimentation of the soy protein product is determined by measuring the total volume of the sample and the volume of the sediment layer. The volume of the sediment layer is then divided by the total volume of the sample and the resulting number is multiplied by 100 to give the sedimentation rate of the soy protein product. Preferably, the soy protein products of the present invention have a sedimentation rate of less than 0.5% by volume and more preferably less than 0.1% by volume when measured using this test. The sedimentation rate of the soy protein products as measured by this test is generally predictive of sedimentation rates of the soy protein products in acidic drinks containing about 3 grams of soy protein product or higher.

Acidic Protein-Containing Drinks

As previously discussed, formation of protein-containing sediment is a common problem for acidic drinks that have been fortified with soy protein, due to the insolubility of the soy protein in the acidic environment present in the drinks. Soy protein products used in acidic drinks also often have a poor aftertaste. The soy protein products of the present invention are suitable for use in an acidic drinks, while having less or no sedimentation and a reduction in astringent aftertaste commonly associated with soy protein fortified acidic drinks.

Because the soy protein products of the present invention have improved solubility in acidic environments, they are ideally suited for use in acidic, protein-containing drinks. Thus, in one embodiment, an acidic, protein-containing drink is formulated using a soy protein isolate of the present invention. Preferably, the acidic, protein-containing drink comprises from about 0.6 wt. % to about 4.6 wt. % of the soy protein isolate, and more preferably from about 1.5 wt. % to about 3.2 wt. % of the soy protein isolate. Alternately, the acidic, protein-containing drink can also be formulated using the soy protein concentrate of the present invention. In this instance, the acidic, protein-containing drink preferably comprises from about 0.7 wt. % to about 5.7 wt. % of the soy protein concentrate, and more preferably from about 1.9 wt. % to about 4.0 wt. % of the soy protein concentrate.

In preparing the acidic, protein-containing drinks, it is preferable to first hydrate the soy protein isolate or soy protein concentrate to increase the solubility of the soy protein material in an aqueous solution. Methods for hydrating soy protein material are known in the art. Briefly, the soy protein product may be hydrated by dispersing the soy protein isolate or concentrate in an aqueous solution, preferably water or a pH adjusted aqueous alkali, having a pH significantly above or below the isoelectric point of the protein, preferably a pH of greater than 5.5 or less than 3.0, so the protein does not precipitate out from the solution. The amount of protein hydrated in the aqueous solution is preferably from about 0.6% to about 16% (by weight of the final acidic, protein-containing drink), and the amount of aqueous solution in which the protein is hydrated is preferably at least 4 times the amount of protein material by weight. Preferably, the aqueous solution in which the protein material is hydrated is from 65% to 90% by weight of the final acidic, protein-containing drink.

The aqueous solution in which the soy protein product is hydrated is preferably heated above ambient temperature prior to, or upon, addition of the soy protein product to the hydrating solution to facilitate hydration of the soy protein product. Preferably the aqueous hydrating solution is heated to a temperature of from about 110° F. to about 170° F. (about 43° C. to about 77° C.) to aid in the hydration of the protein material therein, and is preferably maintained at this temperature for about 5 to about 60 minutes, preferably for about 10 minutes. The temperature of the hydrating solution may be further adjusted, if desired, to speed the hydration of the protein material. Preferably the temperature of the hydrating solution is adjusted to a temperature of from about 150° F. to about 180° F. (about 65° C. to about 82° C.).

After hydration of the soy protein product, non-acidic flavoring agents, defoamers, coloring agents, nutrients, and sweeteners may be added to the aqueous hydrating solution. Flavoring agents include commercially available natural and artificial flavors, including concentrated fruit or vegetable juices. Coloring agents may be commercially available natural and artificial colorants. Preferred sweeteners are carbohydrates such as sucrose and fructose, and include high fructose corn syrup. Nutrients such as vitamins and minerals may also be added.

After addition of the non-acidic flavoring agents, coloring agents, defoamers, nutrients, and sweeteners to the aqueous hydrating solution, the hydrating solution is optionally mixed until the added components are thoroughly distributed in the hydrating solution. If the temperature of the hydrating solution has not already been adjusted, the temperature of the hydrating solution may be increased when mixing the added components to ensure that the ingredients in the hydrating solution are optimally mixed. Preferably the temperature of the hydrating solution is raised to about 150° F. to about 180° F. (about 65° C. to about 82° C.).

After the soy protein product is hydrated in the hydrating solution and any desired flavoring agents, coloring agents, defoamers, sweeteners, and nutrients are mixed in the hydrating solution, the hydrating solution is adjusted, if needed, to the desired pH of the final acidic, protein-containing drink. The acidic, protein-containing drinks of the present invention typically have a pH of from about 2.5 to about 4.5, preferably from about 3.0 to about 4.0, and more preferably from about 3.2 to about 3.8. If needed, the hydrating solution may be acidified to the desired pH by adding an acidulent such as an edible acid (e.g. lactic acid, citric acid, phosphoric acid) to the hydrating solution, by mixing the hydrating solution with an acidic liquid such as a fruit or a vegetable juice, by mixing the hydrating solution with an acidic fruit or vegetable juice concentrate, or by combinations of such methods. Alternately, the hydrating solution may be made more basic, if needed, by adding a base, preferably a dilute alkaline solution such as an aqueous sodium or potassium hydroxide solution, or by adding sufficient quantities of a juice or juice concentrate to raise the pH of the hydrating solution to the desired pH of the acidic, protein-containing drink. Most preferably, the hydrating solution containing the soy protein product and other ingredients is acidified to a pH other than the isoelectric point of the protein material to avoid maximum insolubility of the protein in the acidified solution.

In one embodiment of the invention, the hydrating solution containing the hydrated protein and other ingredients is mixed with a juice or a juice concentrate to provide an aqueous acidic liquid drink. Preferred fruit and vegetable juices and juice concentrates include apple juice, grape juice, orange juice, carrot juice, lemon juice, lime juice, grapefruit juice, pineapple juice, cranberry juice, peach juice, pear juice, celery juice, cherry juice, tomato juice, passionfruit juice, mango juice, blends thereof, and their concentrates. If the desired pH of the aqueous acidic liquid drink is lower than the pH provided by mixing the juice and/or juice concentrate with the hydrating solution, the pH may be further lowered by adding an edible acidulent to the mixture. Preferred edible acidulents include citric acid, lactic acid, and phosphoric acid.

In another embodiment of the invention the hydrating solution containing the hydrated protein and other ingredients is acidified by adding a sufficient amount of one or more edible acidulents and, if desired, additional flavoring, coloring agents, nutrients, and sweeteners, to the hydrating solution to adjust the pH of the hydrating solution to the desired acid pH. As noted above, preferred edible acidulents include citric acid, lactic acid, phosphoric acid, and ascorbic acid, among others.

In most cases, the acidic, protein-containing drink will be pasteurized or sterilized to eliminate any microbial contamination of the suspension and enable storage stability. The acidic, protein-containing drink is preferably pasteurized with conventional pasteurization equipment at a temperature of from about 175° F. to about 195° F. (about 80° C. to about 90° C.) for 0.5 to 3 minutes.

Because of the good solubility of the soy protein products used in the preparation of the acidic, protein-containing drinks, there is generally no need to homogenize the acidic, protein-containing drinks after the ingredients have been added. However, if the acidic, protein-containing drink is not completely mixed or similar in particle size, it may optionally be homogenized before or after pasteurization. Homogenization may be done by any conventional technique, for example, by high pressure treatment at 1000 to 5000 psi utilizing a valve-type Rannie or Gaulin homogenizer. Optimally the homogenization is done in two stages with the first stage at 2500 psi and the second stage at 500 psi.

Many prior processes of preparing acidic, protein-containing drinks have used protein stabilizing agents to attempt to improve the solubility and stability of soy proteins present in the acidic, protein-containing drinks. In general, stabilizing agents interact with the surfaces of the soy proteins (and other components of the acidic, protein-containing drinks) and stabilize the electrostatic interaction between proteins. This in turn reduces the formation of large protein aggregates, which have reduced solubility and stability in acidic environments, and tend to precipitate out of solution. Commonly used stabilizing agents include, for example, pectin, polysaccharide hydrolysates comprising dextrin, agar, carrageenan, tamarind seed polysaccharides, angelica gum, karaya gum, xanthan gum, sodium alginate, tragacanth gum, guar gum, locust bean gum, pullulan, jellan gum, gum arabic, carboxymethylcellulose, and propylene glycol alginate ester. Advantageously, the acidic, protein-containing drinks of the present invention are substantially free of stabilizers; that is, they contain no stabilizers or only a trace amount of stabilizers not sufficient to affect the properties of the soy proteins. This is particularly advantageous because the addition of stabilizers to acidic, protein-containing drinks may result in the acidic, protein-containing drinks having an increased viscosity and a thicker, unpleasant mouthfeel. In addition, it has been discovered that adding stabilizers such as pectin and hydrocolloids to acidic, protein-containing drinks comprising soy protein products of the present invention may actually result in separation of the drink due to the precipitation of soy proteins.

Since the soy protein products used to prepare the acidic, protein-containing drinks have good solubility, suspendability, and low phytic acid content, there is generally little to no sediment in the acidic, protein-containing drinks of the present invention. The sedimentation rate may be determined by using, for example, the following method: Hot-fill a sample of the acidic, protein-containing drink into a 250 ml Nalgene narrow moth square bottle up to 2 mm from the top. Tightly close the bottle and invert the bottle for about 3 minutes to sterilize the lid and top of the bottle. Place the filled bottle into an ice bath for about 30 minutes to cool the acidic, protein-containing drink to room temperature. Put the bottle into storage at room temperature for 30 days. After 30 days, measure from the benchtop to top of the sediment and deduct 2 mm from the reading for the height of the bottom of the bottle to obtain the height of the sediment. Measure the total volume height. Divide the height of the sediment by the total volume height and multiply the resulting number by 100 to obtain the sedimentation rate. Optionally, this procedure may be repeated and the average of the readings calculated. The sedimentation rate of the acidic, protein-containing drink after 30 days of ambient storage will preferably be less than 0.5% by volume, and optimally is less than 0.1% by volume, as measured by this test.

Furthermore, because the soy protein products used in the acidic, protein-containing drinks comprise only from about 0.1% to about 1.3% (by weight total solids) phytic acid, the acidic, protein-containing drinks comprising these soy protein product will likewise comprise only from about 0.1% to about 1.3% (by weight total protein) phytic acid. As a result of the low phytic acid content and lack of protein stabilizers, the acidic, protein-containing drinks furthermore have a desirable viscosity, preferably from about 2 to about 40 centipoise, and a desirable mouthfeel.

### EXAMPLES

The following examples are simply intended to further illustrate and explain the present invention. The invention, therefore, should not be limited to any of the details in these examples.

### Example 1

In this Example, an acidic, protein-containing drink produced using a process of the present invention and a control sample using a conventional process are prepared. The viscosities of the samples are then analyzed and compared.

To produce the sample using a process of the present invention (Sample A), a mixture of 32.0 grams ascorbic acid, 56.0 grams anhydrous citric acid, and 20.0 grams phosphoric acid (85%) is added to 656.0 grams apple juice concentrate (available from San Joaquin Valley, Fresno, Calif.) producing an acidic beverage having a pH of 2.5. To the acidic beverage, 22,563.2 grams of water is added. 560.0 grams Alpha™ 5812, a commercially available soy protein concentrate (available from The Solae Company, St. Louis, Mo.), is then hydrated in the acidic beverage for 5 minutes with continuous stirring. After the Alpha™ 5812 is sufficiently hydrated to form an acidic, protein-containing solution, 4.503 grams of Novozymes phytase (Batch NS37032 available from Novozymes A/S, Bagsvaerd, Denmark) is introduced into the acidic, protein-containing solution. The enzyme is reacted with the acidic, protein-containing solution for a period of about 25 minutes with continuous stirring. The enzyme treated acidic, protein-containing solution is then heat treated to a temperature of about 85° C. using direct steam ultra heat treatment and held at that temperature for a period of about 5 minutes to form the acidic, protein-containing drink. To the drink, the following optional ingredients are added: 4000.0 grams sucrose, 0.128 grams FD & C Red #40 (available from Senient Color, Inc., St. Louis, Mo.), 1.4 grams FD & C Yellow #6 (available from Senient Color, Inc., St. Louis, Mo.), 3.3 grams Vitamin Premix FT021522 (available from Fortitech, Inc., Schnectady, N.Y.), 20.0 grams mango flavor (available from IFF, Daton, N.J.), and 88.0 grams peach flavor (available from IFF, Daton, N.J.). The acidic, protein-containing drink, which comprises 7 grams of soy protein concentrate/8 ounces of acidic, protein-containing drink, is finally cooled in an ice bath to a temperature of about 25° C.

To produce the control sample (Control Sample B), Supro® Plus 675, commercially available from The Solae Company, St. Louis, Mo., is hydrated in water at a temperature of 82° C. for 10 minutes with continuous mixing. Specifically, Supro® Plus 675 is hydrated in water at a weight ratio of Supro® Plus 675:water of 1:20. In a separate bowl, pectin is hydrated in water having a temperature of 76.7° C. for 10 minutes with continuous stirring. Pectin is hydrated in water at a weight ratio of pectin:water of about 1:32. The solution of Supro® Plus 675 and the solution of pectin are then mixed in a weight ratio of 1:0.20 Supro® Plus 675:pectin using a propeller type mixer at a speed of about 4000 revolutions per minute (rpm) to produce a protein/pectin solution. A blend of 656.0 grams of apple juice concentrate (available from San Joaquin Valley, Fresno, Calif.), 4000.0 grams sucrose, 0.128 grams FD & C Red #40 (available from Senient Color, Inc., St. Louis, Mo.), 1.4 grams FD & C Yellow #6 (available from Senient Color, Inc., St. Louis, Mo.), 3.3 grams Vitamin Premix FT021522 (available from Fortitech, Inc., Schnectady, N.Y.), 20.0 grams mango flavor (available from IFF, Daton, N.J.), and 88.0 grams peach flavor (available from IFF, Daton, N.J.) is then added to the protein/pectin solution. The resulting acidic, protein-containing solution is then pasteurized at 88° C. for 15 seconds using a tubular heat exchanger. The acidic, protein-containing solution is further homogenized. The acidic, protein-containing solution is homogenized at a pressure of 2500 psi/500 psi and a temperature of about 88° C. Finally the acidic, protein-containing solution is cooled in an ice bath to a temperature of 25° C. to produce an acidic, protein-containing drink having 7 grams soy protein isolate/8 ounces acidic beverage.

The viscosities of Sample A and Control Sample B (at 10% solids basis) at a temperature of 25° C. are determined using the Brookfield Method as discussed herein above. Sample A has a viscosity of 2.9 centipoise. Control Sample B has a viscosity of 15.0 centipoise. As the data indicate, Sample A has a lower viscosity than Control Sample B, resulting in Sample A having an improved mouthfeel.

### Example 2

In this example, three samples of acidic, protein-containing drinks according to processes of the present invention and two control samples using a conventional process of producing an acidic, protein-containing drink are prepared. The hardness of sediment values (i.e., shake back times) for the samples are analyzed and compared to determine whether the sediment is hard pack or soft pack.

To produce the three different samples of acidic, protein-containing drink according to processes of the present invention, a mixture of 32.0 grams ascorbic acid, 56.0 grams anhydrous citric acid, and 20.0 grams phosphoric acid (85%) is added to 656.0 grams apple juice concentrate producing an acidic beverage having a pH of 2.5. To the acidic beverage, 22,563.2 grams of water is added. Various amounts (see Table 1) of Alpha™ 5812, a commercially available soy protein concentrate (available from The Solae Company, St. Louis, Mo.), are then hydrated in the acidic beverage for 5 minutes with continuous stirring to form an acidic, protein-containing solution. Two of the sample solutions (Samples C and D) are then heat treated. Specifically, the two samples are heated to a temperature of about 85° C. using direct steam ultra heat treatment (UHT) and held at that temperature for a period of about 5 minutes to form the acidic, protein-containing drinks. The one remaining sample (Sample E) is enzyme treated by adding 4.503 grams of phytase (5000 KPU/gram) (available from Novozymes A/S, Bagsvaerd, Denmark) into the acidic, protein-containing solution. The enzyme is allowed to react with the acidic, protein-containing solution for about 25 minutes. The enzyme treated acidic, protein-containing solution is then heat treated to a temperature of about 85° C. using direct steam UHT and held at that temperature for a period of about 5 minutes to form the acidic, protein-containing drink. After heat treatment, the following optional ingredients are added to all three drink samples: 4000.0 grams sucrose, 0.128 grams FD & C Red #40 (available from Senient Color, Inc., St. Louis, Mo.), 1.4 grams FD & C Yellow #6 (available from Senient Color, Inc., St. Louis, Mo.), 3.3 grams Vitamin Premix FT021522 (available from Fortitech, Inc., Schnectady, N.Y.), 20.0 grams mango flavor (available from IFF, Daton, N.J.), and 88.0 grams peach flavor (available from IFF, Daton, N.J.). All three acidic, protein-containing drink samples are finally cooled in an ice bath to a temperature of about 25° C.

To produce the control samples (Control Samples A & B), Alpha™ 5812, commercially available from The Solae Company, St. Louis, Mo., is hydrated in water having a temperature of 82° C. for 10 minutes to produce a solution containing about 3.5% (by weight) Alpha™ 5812. In a separate bowl, pectin is hydrated in water having a temperature of 76.7° C. for 10 minutes to make a solution containing 3.0% (by weight) pectin. The solution of Alpha™ 5812 and the solution of pectin are then mixed in a weight ratio of 1:0.0065 Alpha™ 5812:pectin using a propeller type mixer at a speed of about 4000 revolutions per minute (rpm) to produce a protein/pectin solution. A blend of 656.0 grams of apple juice concentrate (available from San Joaquin Valley, Fresno, Calif.), 4000.0 grams sucrose, 0.128 grams FD & C Red #40 (available from Senient Color, Inc., St. Louis, Mo.), 1.4 grams FD & C Yellow #6 (available from Senient Color, Inc., St. Louis, Mo.), 3.3 grams Vitamin Premix FT021522 (available from Fortitech, Inc., Schnectady, N.Y.), 20.0 grams mango flavor (available from IFF, Daton, N.J.), and 88.0 grams peach flavor (available from IFF, Daton, N.J.) is then added to the protein/pectin solution to form an acidic, protein-containing solution.

One of the acidic, protein-containing solutions (Control Sample A) is heated to a temperature of about 88° C. using indirect steam UHT and held at that temperature for a period of about 5 minutes. The other acidic, protein-containing solution (Control Sample B) is heated to a temperature of about 88° C. using direct stem injection UHT and held at that temperature for 5 minutes.

Both of the control acidic, protein-containing solutions are further homogenized in a two-stage process. During the first stage, the acidic, protein-containing solution is homogenized at a pressure of 2500 psi and a temperature of about 87.7° C. During the second stage, the acidic, protein-containing solution is homogenized at a pressure of 500 psi and a temperature of about. Finally the acidic, protein-containing solution is cooled in an ice bath to a temperature of 25° C. to produce an acidic, protein-containing drink having 7 grams soy protein isolate/8 ounces acidic beverage.

The five samples, the amount of Alpha™ 5812 in each sample, whether the sample is enzyme treated, and what type of heat treatment is used in each sample are shown in Table 1:

TABLE 1

| | Amount of | | |
|---|---|---|---|
| | Alpha ™ 5812 | | |
| | (grams/8 oz | | |
| | acidified | | |
| | juice concentrate | Enzyme | |
| Sample | blend solution) | Treatment | Heat Treatment Used |
| Control A | 6.5 | No | Indirect Steam UHT |
| Control B | 6.5 | No | Direct Steam Injection UHT |
| C | 3.0 | No | Direct Steam Injection UHT |
| D | 5.0 | No | Direct Steam Injection UHT |
| E | 3.0 | Yes | Direct Steam Injection UHT |

The hardness of sediment values for the five samples are analyzed using a shake-back test. Generally, a shake-back test quantifies the hardness of sediment in an acidic, protein-containing drink. Specifically, the harder the sediment, the more shaking must be conducted to re-suspend the sediment into the acidic, protein-containing drink and the longer the shake-back time will be. In this Example, the shake-back test includes first placing a sample of acidic, protein-containing drink into a 250-milliliter bottle (available as Nalgene part no. 2019-0250, from Nalge Nunc International Corporation, Rochester, N.Y.), which is made of polyethylene terephthalate copolyester and has a white high-density polyethylene screw closure, and then placing the bottle upside down on a clamp of a Burrell Wrist-Action Shaker (available from Burrell Scientific, Inc., Pittsburgh, Pa.). The Burrell Wrist-Action Shaker has an arc travel of 10 degrees at a frequency of 200 plus or minus 20 oscillations per minute (osm). The Shaker is set at a shaker speed of 3. The Shaker is started simultaneously with a stop watch. After 5 seconds, the Shaker and stop watch are stopped, and the bottom of the bottle is observed. If the bottom is clear, the test is stopped and the time is recorded. If the bottom is not clear, the Shaker and stop watch are again started and shaking continues for another 5 seconds. Again, the bottom of the bottle is observed. If the bottom is clear, the test is stopped and the time is recorded (i.e., 10 seconds). This process is repeated at 5 second intervals until the bottom of the bottle is clear. Each sample is run through the shake-back test two to five times and the shake-back times for each sample are averaged. The results of the shake-back test are shown in Table 2:

TABLE 2

| | Runs through | Average Shake-back |
|---|---|---|
| Sample | Shake-back Test | Time (seconds) |
| Control A | 2 | 75 |
| Control B | 2 | 25 |
| C | 5 | 3 |
| D | 5 | 4 |
| E | 2 | 1 |

As shown in Table 2, all three of the samples produced using the processes of the present invention have shake back times significantly shorter than the control samples made with conventional processes. Specifically, a clear solution was observed in Samples C, D, and E before the first 5-second interval was finished. Additionally, in general, the more plant protein material (i.e., Alpha™ 5812) added per acidic beverage, the longer the shake-back time to re-suspend the sediment (i.e., a harder pack sediment). Furthermore, as shown in Table 2, acidic, protein-containing drinks produced using an enzyme treatment, had a shorter shake-back time (i.e., a softer pack sediment) than the acidic, protein-containing drinks produced without an enzyme treatment.

### Example 3

In this Example, soy protein isolates that have been treated with a phytic acid degrading enzyme during processing are produced.

To obtain the soy protein isolates, identity preserved (IP) defatted soy flakes (10 lbs/min) are extracted at a water temperature of 92° F. (33° C.) and at a pH of about 9.86 using lime and a water to flake ratio of 10:1. The extractant is then separated from the spent flakes via centrifugation at a speed of 4000 revolutions per minute (rpm). A second extraction is subsequently performed on the recovered flakes using a water to flake ratio of 6:1 at a water temperature of 92° F. (33° C.), followed by a second separation via centrifugation at a speed of 4000 rpm and a pH of about 9.77. The two extracts are combined to form a combined extract having a pH of about 9.95. The combined extract is further clarified by washing for 10 minutes (2.0% overflow volume solids; 5.7% underflow volume solids) to remove residual fiber present in the extract. Hydrochloric acid (HCl) is then added to the combined, clarified extract, lowering the pH to about 4.53. The extract remains at this pH for about 10 minutes to equilibrate, and forms a precipitated soy protein material from the soy protein extract. The remaining carbohydrates are separated from the precipitated soy protein by continuous centrifugation. The first separation is completed by continuously washing the precipitated soy protein with water at a rate of 39 lbs/min, and at a temperature of about 92° F. (33° C.), and centrifuging at a speed of 4000 rpm. The underflow (soy protein containing stream) is contacted with water at a rate of 70 lbs/min, heated to 139° F. (59.4° C.), and centrifuged at a speed of 4000 bowl rpm and 3000 pinion rpm. The resulting soy protein curd is then hydrated in a water solution to approximately 25% total solids, and placed in a hold tank.

Two precipitated soy protein curd suspensions are produced by this process, and are used to prepare five samples. The precipitated soy protein curd suspensions are diluted to about 10.68% (by weight) solids). Novozymes phytase (Novozymes, Bagsvaerd, Denmark) is then added to the first precipitated soy protein curd suspension (pH 4.5) at a concentration of 0.20% CSB, and the resulting suspension is mixed at 125° F. (51.7° C.) for 30 minutes to allow reaction of the enzyme with phytic acid. After mixing, the enzyme reaction is stopped by heating the suspension to 180° F. (82.2° C.). Then, a sodium hydroxide/potassium hydroxide blend (NaOH/KOH=42%:58%) is added to the suspension, raising the pH to about 5.10. The suspension is diluted with adequate amounts of water in order to obtain a level of about 5% (by weight) CEM solids, followed by an additional separation step (centrifugation at a bowl speed of 4000 rpm, a pinion speed of 2500 rpm, at 135° F. (57° C.)), and the resulting phytase treated precipitated soy protein curd is again diluted with water in order to adjust the total solids to approximately 25% (sample 1).

The second precipitated soy protein curd suspension is divided into four samples (samples 2-5) for further treatment. The control sample (sample 2), 11.24% CEM solids, was not treated with a phytic acid degrading enzyme. Samples 3-5 are treated with phytic acid degrading enzymes. Sample 3 (pH 4.45, 11.27% CEM solids) is treated with Amano 3000 phytase (Amano Pharmaceutical Co., LTD, Nagoya, Japan) at a concentration of 0.14% CSB; samples 4 (pH 4.49, 11.43% CEM solids) and 5 (pH 4.47, 11.12% CEM solids) are treated with Novozymes phytase (Novozymes, Bagsvaerd, Denmark) at concentrations of 0.084% CSB and 0.20% CSB, respectively. The resulting suspensions are mixed at 125° F. (52° C.) for 30 minutes. After reacting with the phytic acid degrading enzyme, the suspensions are heated to 180° f. to stop the reaction. Samples 3-5 each registered a drop in pH following phytase treatment (pH of sample 3 was 3.96, pH of sample 4 was 3.75; pH of sample 5 was 3.69). Samples 3-5 were not subjected to an additional separation step following phytase treatment.

After treatment with the phytic acid degrading enzyme, samples 1 to 5 are subsequently adjusted to a neutral pH by adding a sodium hydroxide/potassium hydroxide blend (NaOH/KOH=42%:58%) in an amount sufficient to raise the pH of each sample into a neutral range. After addition of the NaOH/KOH blend, the pH of samples 1 to 5 were 7.06, 7.01, 6.96, 7.15, and 7.10, respectively.

Following neutralization, the samples are heat treated using jet cooking at 287° F. to 288° F. (142° C.) for 9 seconds to pasteurize the samples. Finally, the samples are spray dried (inlet temperature of 499° F. (259.4° C.), 491° F. (255° C.), 489° F. (253.9C.°), 494° F. (256.7° C.), and 494° F. (256.7° C.) for samples 1-5, respectively, and an outlet temperature of 200° F. (93.3° C.)) at a neutral pH to form soy protein isolates. The samples, type of phytase treatment, and spray dry pH are shown in Table 3:

TABLE 3

| | Phytic Acid | Enzyme Concentration | |
|---|---|---|---|
| Sample | Degrading Enzyme | (% CSB) | Spray Dry pH |
| 1 | Novozymes phytase | 0.20 | 6.94 |
| 2 | N/A | N/A | 6.60 |
| 3 | Amano 3000 phytase | 0.14 | 6.94 |
| 4 | Novozymes phytase | 0.084 | 7.02 |
| 5 | Novozymes phytase | 0.20 | 6.92 |

In view of the above, it will be seen that the several objects of the invention are achieved and other advantageous results obtained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

The term “by weight” is used throughout the application to describe the amounts of components in the acidic, protein-containing drinks. Unless otherwise specified, the term “by weight” is intended to mean by weight on an as is basis, without any moisture added or removed from the product. The term by weight dry basis is intended to mean on a moisture-free basis, in which the moisture has been removed.

As various changes could be made in the above without departing from the scope of the invention, it is intended that all matter contained in the above description and shown in the accompanying drawings shall be interpreted as illustrative and not in a limiting sense.

What is claimed is:

1. A process for producing an acidic, protein-containing drink, the process comprising:
adjusting the pH of an acidic beverage to a pH of from about 1 to about 4.4;
hydrating a plant protein material in the acidic beverage to form an acidic, protein-containing solution;
introducing an enzyme into the acidic, protein-containing solution;
heating the enzyme treated acidic, protein-containing solution to a temperature of from about 85° C. to about 95° C. and holding the enzyme treated acidic, protein-containing solution at that temperature for a period of from about 30 seconds to about 50 minutes to form the acidic, protein-containing drink.

2. The process as set forth in claim 1 wherein the acidic, protein-containing solution comprises from about 0.5% (by weight) to about 10% (by weight) plant protein material.

3. The process as set forth in claim 1 wherein the plant protein material is selected from the group consisting of soy protein material, rapeseed protein material, wheat gluten material, pea protein material, lupin protein material, rice protein material, and legume protein material.

4. The process as set forth in claim 1 wherein the plant protein material is a soy protein material selected from the group consisting of soymilk or soymilk concentrates, soy flakes, soy flour, soy grits, soy meal, soy protein concentrates, soy protein isolates, and mixtures thereof.

5. The process as set forth in claim 1 wherein the enzyme is a phytic acid degrading enzyme.

6. The process as set forth in claim 5 wherein the phytic acid degrading enzyme is reacted with the acidic, protein-containing solution for a period of about 25 minutes prior to the heating of the enzyme treated acidic, protein-containing solution.

7. The process as set forth in claim 6 wherein about 50 KPU (per gram plant protein material) to about 100 KPU (per gram plant protein material) phytic acid degrading enzyme is introduced into the acidic, protein-containing solution.

8. The process as set forth in claim 1 further comprising homogenizing the acidic, protein-containing drink.

9. The process as set forth in claim 1 further comprising cooling the acidic, protein-containing drink to a temperature of about 25° C. after heat treatment.

10. The process as set forth in claim 1 further comprising adjusting the pH of the acidic, protein-containing drink to a pH of from about 2.0 to about 5.0.

11. The process as set forth in claim 1 further comprising adding a mouthfeel modifying agent to the acidic beverage prior to pH adjustment.

12. An acidic, protein-containing drink comprising from about 0.5% (by weight) to about 10% (by weight) plant protein material and having a pH of from about 2.0 to about 5.0, the acidic, protein-containing drink having a viscosity (at 10% solids basis) at a temperature of about 25° C. of from about 1.0 centipoise to about 10 centipoise, and less than about 3% sedimentation at day 30.

13. The acidic, protein-containing drink as set forth in claim 12 where in the plant protein material is selected from the group consisting of soy protein material, rapeseed protein material, wheat gluten material, pea protein material, lupin protein material, rice protein material, and legume protein material.

14. The acidic, protein-containing drink as set forth in claim 12 wherein the plant protein material is a soy protein material selected from the group consisting of soymilk or soymilk concentrates, soy flakes, soy flour, soy grits, soy meal, soy protein concentrates, soy protein isolates, and mixtures thereof.

15. The acidic, protein-containing drink as set forth in claim 12 further comprising a mouthfeel modifying agent.

16. The acidic, protein-containing drink as set forth in claim 15 comprising from about 0.01% (by weight) to about 15% (by weight) mouthfeel modifying agent.

17. A process for producing an acidic, protein-containing drink, the process comprising:
adjusting the pH of an acidic beverage to a pH of from about 1 to about 3.8;
hydrating a plant protein material in the acidic beverage to form an acidic, protein-containing solution;
heating the acidic, protein-containing solution to a temperature of from about 85° C. to about 95° C. and
holding the acidic, protein-containing solution at that temperature for a period of from about 30 seconds to about 50 minutes to form the acidic, protein-containing drink.

18. The process as set forth in claim 17 wherein the acidic, protein-containing solution comprises from about 0.5% (by weight) to about 10% (by weight) plant protein material.

19. The process as set forth in claim 17 wherein the plant protein material is selected from the group consisting of soy protein material, rapeseed protein material, wheat gluten material, pea protein material, lupin protein material, rice protein material, and legume protein material.

20. The process as set forth in claim 17 wherein the plant protein material is a soy protein material selected from the group consisting of soymilk or soymilk concentrates, soy flakes, soy flour, soy grits, soy meal, soy protein concentrates, soy protein isolates, and mixtures thereof.

21. The process as set forth in claim 17 further comprising homogenizing the acidic, protein-containing drink.

22. The process as set forth in claim 17 further comprising cooling the acidic, protein-containing drink to a temperature of 25° C. after heat treatment.

23. The process as set forth in claim 17 further comprising adjusting the pH of the acidic, protein-containing drink to a pH of from about 2.0 to about 5.0.

24. An acidic, protein-containing drink comprising from about 0.5% (by weight) to about 10% (by weight) plant protein material and having a pH of from about 2.0 to about 5.0, the acidic, protein-containing drink having a viscosity (at 10% solids basis) at a temperature of about 25° C. of from about 1.0 centipoise to about 10 centipoise, and less than about 3% sedimentation at day 30, and wherein the acidic, protein-containing drink is substantially free of a mouthfeel modifying agent.

25. The acidic, protein-containing drink as set forth in claim 24 wherein the plant protein material is selected from the group consisting of soy protein material, rapeseed protein material, wheat gluten material, pea protein material, lupin protein material, rice protein material, and legume protein material.

26. The acidic, protein-containing drink as set forth in claim 24 wherein the plant protein material is a soy protein material selected from the group consisting of soymilk or soymilk concentrates, soy flakes, soy flour, soy grits, soy meal, soy protein concentrates, soy protein isolates, and mixtures thereof.

27. A process for producing a soy protein product, the process comprising:
preparing a soy protein extract from a soy protein-containing plant material;
contacting the soy protein extract with an acid to form a soy protein precipitate;
contacting the soy protein precipitate with a hydrating solution to form a soy protein suspension;
introducing a phytic acid degrading enzyme into the soy protein suspension and reacting the soy protein suspension with the phytic acid degrading enzyme for from about 30 seconds to about 50 minutes to form a modified soy protein material;
adjusting the pH of the modified soy protein material to a pH of from about 6.5 to about 8.0 to form a neutralized soy protein material;
heating the neutralized soy protein material to a temperature of from about 132° C. to about 160° C. for from about 1 second to about 30 seconds to form a heat treated soy protein material; and
drying the heat treated soy protein material to form the soy protein product;
wherein the soy protein product comprises from about 0.1% (by weight total solids) to about 1.3% (by weight total solids) phytic acid.

28. The process as set forth in claim 27 wherein about 0.01% (by weight total solids) to about 0.5% (by weight total solids) phytic acid degrading enzyme is introduced into the soy protein suspension.

29. An acidic, protein-containing drink comprising:
a hydrated soy protein product, wherein the soy protein product prior to hydration is prepared by the process as set forth in claim 27; and
wherein the acidic, protein-containing drink has a pH of from about 2.5 to about 4.5, and is substantially free of a protein stabilizing agent.

30. The acidic, protein-containing drink as set forth in claim 29 wherein the soy protein product is a soy protein isolate and the acidic, protein-containing drink comprises from about 0.6 wt. % to about 4.6 wt. % of the soy protein isolate.

31. The acidic, protein-containing drink as set forth in claim 29 wherein the soy protein product is a soy protein concentrate and the acidic, protein-containing drink comprises from about 0.7 wt. % to about 5.7 wt. % of the soy protein concentrate.

32. A process for producing a soy protein product, the process comprising:
preparing a soy protein extract from a soy protein-containing plant material;
introducing a phytic acid degrading enzyme into the soy protein extract and reacting the soy protein extract with the phytic acid degrading enzyme for from about 30 seconds to about 50 minutes to form a modified soy protein extract;
contacting the modified soy protein extract with an acid to form a modified soy protein precipitate;
contacting the modified soy protein precipitate with a hydrating solution to form a modified soy protein suspension;
adjusting the pH of the modified soy protein suspension to a pH of from about 6.5 to about 8.0 to form a neutralized soy protein material;
heating the neutralized soy protein material to a temperature of from about 132° C. to about 160° C. for from about 1 second to about 30 seconds to form a heat treated soy protein material; and
drying the heat treated soy protein material to form the soy protein product;
wherein the soy protein product comprises from about 0.1% (by weight total solids) to about 1.3% (by weight total solids) phytic acid.

33. The process as set forth in claim 32 wherein about 0.01% (by weight total solids) to about 0.5% (by weight total solids) phytic acid degrading enzyme is introduced into the soy protein extract.

34. An acidic, protein-containing drink comprising:
a hydrated soy protein product, wherein the soy protein product prior to hydration is prepared by the process as set forth in claim 32; and
wherein the acidic, protein-containing drink has a pH of from about 2.5 to about 4.5, and is substantially free of a protein stabilizing agent.

35. The acidic, protein-containing drink as set forth in claim 34 wherein the soy protein product is a soy protein isolate and the acidic, protein-containing drink comprises from about 0.6 wt. % to about 4.6 wt. % of the soy protein product.

36. The acidic, protein-containing drink as set forth in claim 34 wherein the soy protein product is a soy protein concentrate and the acidic, protein-containing drink comprises from about 0.7 wt. % to about 5.7 wt. % of the soy protein concentrate.

37. A process for producing a soy protein product, the process comprising:
preparing a soy protein extract from a soy protein-containing plant material;
contacting the soy protein extract with an acid to form a soy protein precipitate;
contacting the soy protein precipitate with a hydrating solution to form a soy protein suspension;
adjusting the pH of the soy protein suspension to a pH of from about 6.5 to about 8.0 to form a neutralized soy protein material;
introducing a phytic acid degrading enzyme into the neutralized soy protein material and reacting the neutralized soy protein material with the phytic acid degrading enzyme for from about 30 seconds to about 50 minutes to form a modified soy protein material, wherein the pH of the modified soy protein material is from about 6.5 to about 8.0;
heating the modified soy protein material to a temperature of from about 132° C. to about 160° C. for from about 1 second to about 30 seconds to form a heat treated soy protein material; and
drying the heat treated soy protein material to form the soy protein product;
wherein the soy protein product comprises from about 0.1% (by weight total solids) to about 1.3% (by weight total solids) phytic acid.

38. An acidic, protein-containing drink comprising:
a hydrated soy protein product, wherein the soy protein product prior to hydration is prepared by the process as set forth in claim 37; and
wherein the acidic, protein-containing drink has a pH of from about 2.5 to about 4.5, and is substantially free of a protein stabilizing agent.

39. The acidic, protein-containing drink as set forth in claim 38 wherein the soy protein product is a soy protein isolate and the acidic, protein-containing drink comprises from about 0.6 wt. % to about 4.6 wt. % of the soy protein isolate.

40. The acidic, protein-containing drink as set forth in claim 38 wherein the soy protein product is a soy protein concentrate and the acidic, protein-containing drink comprises from about 0.7 wt. % to about 5.7 wt. % of the soy protein concentrate.
